(19) United States
(12) Patent Application Publication
(10) Pub. No.: US 2026/0086682 A1
(43) Pub. Date: Mar. 26, 2026

(54) SENSOR CONTROLLER, ELECTRONIC APPARATUS, ELECTRONIC PEN, CONTROL METHOD OF SENSOR CONTROLLER, AND POSITION DETECTION SYSTEM

(71) Applicant: Wacom Co., Ltd., Saitama (JP)

(72) Inventors: Yoshio NOMURA, Saitama (JP); Jun KADOWAKI, Saitama (JP)

(73) Assignee: Wacom Co., Ltd., Saitama (JP)

(21) Appl. No.: 19/328,942

(22) Filed: Sep. 15, 2025

(30) Foreign Application Priority Data
Sep. 24, 2024 (JP) 2024-165326
Feb. 17, 2025 (JP) 2025-023223
Apr. 30, 2025 (JP) 2025-075545

(51) Int. Cl. G06F 3/044; G06F 3/0354; G06F 3/041

(52) U.S. Cl. CPC G06F 3/0442; G06F 3/03545; G06F 3/04144; G06F 3/04162; G06F 3/0418; G06F 3/0446; G06F 2203/04105

(57) ABSTRACT

A sensor controller includes an obtaining section configured to obtain a position signal indicating a position of an electronic pen from a pen sensor configured to detect the position of the electronic pen. The sensor controller includes a pen pressure calculating section configured to calculate a pen pressure value regarding a pen pressure of the electronic pen on the pen sensor on the basis of a change in a signal level of the position signal obtained by the obtaining section.

### BACKGROUND

### Technical Field

The present disclosure relates to a sensor controller, an electronic apparatus, an electronic pen, a control method of the sensor controller, and a position detection system, and particularly relates to an electronic apparatus that receives a position indication by an electronic pen and makes a screen display.

### Description of the Related Art

A pen sensor for detecting a position indication by an electronic pen and an electronic apparatus including a display unit that makes a screen display according to detection of the pen sensor are conventionally known. With regard to such an electronic apparatus, technology relating to detecting a pen pressure of the electronic pen on the pen sensor is known.

With regard to this, Japanese Patent No. 7109201 discloses a sensor for detecting a position indicated by an electronic pen and a sensor controller (electronic apparatus). The sensor controller, according to a reception strength of a downlink signal transmitted from the electronic pen to the sensor, corrects a pen pressure indicated by a pen pressure signal transmitted from the electronic pen including a pen pressure detecting portion.

For electronic pens that can detect pen pressure, accuracy of calculating the pen pressure may vary due to manufacturing variation in a pen pressure switch designed for detecting the pen pressure, and the like. With the technology described in Japanese Patent No. 7109201, there is a decrease in accuracy of determining contact of the electronic pen with the pen sensor and calculating the level of the pen pressure when there is variation in the accuracy of calculating the pen pressure of the electronic pen.

Further, for electronic pens that can detect the pen pressure, the pressure applied to the pen pressure switch for detecting the pen pressure may change according to a degree of inclination of the electronic pen with respect to the pen sensor. With the technology described in Japanese Patent No. 7109201, the determination of contact of the electronic pen with the pen sensor is dulled when the inclination of the electronic pen with respect to the pen sensor is large.

### BRIEF SUMMARY

The present disclosure has been made in view of such problems mentioned above. It is an object of the present disclosure to provide a sensor controller, an electronic apparatus, an electronic pen, a control method of the sensor controller, and a position detection system that can calculate a pen pressure of the electronic pen on a pen sensor with high accuracy.

In order to solve the above problems, a sensor controller according to a first aspect of the present disclosure includes an obtaining section configured to obtain a position signal indicating a position of an electronic pen from a pen sensor configured to detect the position of the electronic pen, and a pen pressure calculating section configured to calculate a pen pressure value regarding a pen pressure of the electronic pen on the pen sensor on the basis of a change in a signal level of the position signal obtained by the obtaining section.

In addition, in the sensor controller according to a second aspect of the present disclosure, the signal level is a potential, and, when the potential of the position signal has risen by a first potential or more within a predetermined time, the pen pressure calculating section determines that an operation state has made a transition to a first state in which the electronic pen is pressing the pen sensor, and the pen pressure calculating section calculates the pen pressure value as a first value.

In addition, in the sensor controller according to a third aspect of the present disclosure, when the potential of the position signal has fallen by a second potential or more within a predetermined time, the pen pressure calculating section determines that the operation state has made a transition to a second state in which the electronic pen is separated from the pen sensor, and the pen pressure calculating section calculates the pen pressure value as a second value different from the first value.

In addition, in the sensor controller according to a fourth aspect of the present disclosure, when the operation state has made a transition from the second state to the first state, the pen pressure calculating section calculates the pen pressure value in such a manner as to make the pen pressure value change from the first value to the second value stepwise.

In addition, in the sensor controller according to a fifth aspect of the present disclosure, the signal level is a potential, the obtaining section obtains, from the pen sensor, a pen pressure signal that is transmitted from the electronic pen to the pen sensor and that indicates the pen pressure of the electronic pen on the pen sensor, and the pen pressure calculating section calculates the pen pressure value by correcting the pen pressure indicated by the pen pressure signal on the basis of a change in the potential of the position signal.

In addition, in the sensor controller according to a sixth aspect of the present disclosure, when the potential of the position signal has risen by a first potential or more within a predetermined time, the pen pressure calculating section determines that an operation state has made a transition to a first state in which the electronic pen is pressing the pen sensor, and the pen pressure calculating section calculates the pen pressure value as a first value, and when the pen pressure signal obtained by the obtaining section indicates that the electronic pen is pressing the pen sensor before the pen pressure calculating section determines that the operation state has made a transition to the first state, the pen pressure calculating section determines that the pen pressure signal is indicating an abnormal value, and the pen pressure calculating section calculates the pen pressure value as a second value different from the first value.

In addition, in the sensor controller according to a seventh aspect of the present disclosure, when the potential of the position signal has fallen by a second potential or more within a predetermined time, the pen pressure calculating section determines that the operation state has made a transition to a second state in which the electronic pen is separated from the pen sensor, and the pen pressure calculating section calculates the pen pressure value as the second value, and when the pen pressure signal obtained by the obtaining section indicates that the pen sensor is separated from the electronic pen before the pen pressure calculating section determines that the operation state has made a transition to the second state, the pen pressure calculating section determines that the pen pressure signal is indicating an abnormal value, and the pen pressure calculating section maintains the pen pressure value.

In addition, a control method of a sensor controller according to an eighth aspect of the present disclosure is a control method of a sensor controller connected to a pen sensor, the control method including obtaining a position signal indicating a position of an electronic pen from the pen sensor configured to detect the position of the electronic pen, and calculating a pen pressure value regarding a pen pressure of the electronic pen on the pen sensor on the basis of a change in a signal level of the obtained position signal.

In addition, an electronic apparatus according to a ninth aspect of the present disclosure is an electronic apparatus including the sensor controller according to the first aspect of the present disclosure, a display panel configured to display a display target, and the pen sensor provided to overlap a display region of the display panel in a plan view and configured to detect the position of the electronic pen.

In addition, an electronic pen according to a tenth aspect of the present disclosure is an electronic pen for indicating a position on a pen sensor, the electronic pen including a pen tip that is provided to a distal end thereof to be capable of reciprocating along an axial direction and has an electrode configured to transmit and receive signals to and from the pen sensor, a pen controller configured to calculate a pen pressure value regarding a pen pressure on the basis of a change in a signal level of an uplink signal transmitted from the pen sensor via the electrode, and a transmitting unit configured to transmit a pen pressure signal indicating the pen pressure value calculated by the pen controller and a position signal indicating the position indicated on the pen sensor to the pen sensor via the electrode.

In addition, in the electronic pen according to an eleventh aspect of the present disclosure, the signal level is a potential, and, when the potential of the uplink signal has risen by a first potential or more within a predetermined time, the pen controller determines that an operation state has made a transition to a first state in which the electronic pen is pressing the pen sensor, and the pen controller calculates the pen pressure value as a first value.

In addition, in the electronic pen according to a twelfth aspect of the present disclosure, when the potential of the uplink signal has fallen by a second potential or more within a predetermined time, the pen controller determines that the operation state has made a transition to a second state in which the electronic pen is separated from the pen sensor, and the pen controller calculates the pen pressure value as a second value different from the first value.

In addition, the electronic pen according to a thirteenth aspect of the present disclosure further includes a pressure sensor configured to detect a pressure applied to the pen tip, in which the signal level is a potential, and the pen controller calculates the pen pressure value by correcting the pressure detected by the pressure sensor on the basis of a change in the potential of the uplink signal.

In addition, in the electronic pen according to a fourteenth aspect of the present disclosure, the signal level is a potential, and, when the potential of the uplink signal has risen by a first potential or more within a predetermined time, the pen controller determines that an operation state has made a transition to a first state in which the electronic pen is pressing the pen sensor, and the pen controller calculates the pen pressure value as a first value, and when the pen pressure signal indicates that the electronic pen is pressing the pen sensor before the pen controller determines that the operation state has made a transition to the first state, the pen controller determines that the pen pressure signal is indicating an abnormal value, and the pen controller calculates the pen pressure value as a second value different from the first value.

In addition, in the electronic pen according to a fifteenth aspect of the present disclosure, when the potential of the uplink signal has fallen by a second potential or more within a predetermined time, the pen controller determines that the operation state has made a transition to a second state in which the electronic pen is separated from the pen sensor, and the pen controller calculates the pen pressure value as the second value, and when the pen pressure signal indicates that the electronic pen is separated from the pen sensor before the pen controller determines that the operation state has made a transition to the second state, the pen controller determines that the pen pressure signal is indicating an abnormal value, and the pen controller maintains the pen pressure value.

In addition, a position detection system according to a sixteenth aspect of the present disclosure is a position detection system including the electronic pen according to the tenth aspect of the present disclosure, and an electronic apparatus including a display panel configured to display a display target, the pen sensor that is provided to overlap a display region of the display panel in a plan view, transmits the uplink signal to the electronic pen, and detects the pen pressure signal and the position signal transmitted from the electronic pen, and a sensor controller configured to perform display control on the display panel according to the pen pressure signal and the position signal detected by the pen sensor.

In addition, a sensor controller according to a seventeenth aspect of the present disclosure includes an obtaining section configured to obtain, from a pen sensor configured to detect a position of an electronic pen, a first signal transmitted from a first electrode of the electronic pen to the pen sensor, a second signal transmitted from a second electrode of the electronic pen, the second electrode being different from the first electrode, to the pen sensor, and a pen pressure signal indicating a pen pressure of the electronic pen, and a pen pressure calculating section configured to calculate a pen pressure value regarding the pen pressure of the electronic pen on the pen sensor on the basis of changes in signal levels of the first signal and the second signal obtained by the obtaining section as well as the pen pressure signal obtained by the obtaining section.

In addition, in the sensor controller according to an eighteenth aspect of the present disclosure, the pen pressure calculating section calculates the pen pressure value such that, the larger an inclination angle of the electronic pen with respect to a detecting surface of the pen sensor, the larger the pen pressure value, and the smaller the inclination angle, the smaller the pen pressure value.

In addition, in the sensor controller according to a nineteenth aspect of the present disclosure, the signal levels are potentials, and, when the potential of the first signal or the second signal has risen by a first potential or more within a predetermined time, the pen pressure calculating section determines that an operation state has made a transition to a first state in which the electronic pen is pressing the pen sensor, and the pen pressure calculating section calculates the pen pressure value as a first value.

In addition, in the sensor controller according to a twentieth aspect of the present disclosure, the signal levels are potentials, and, when a potential difference between the first signal and the second signal has risen by a first potential or more within a predetermined time, the pen pressure calculating section determines that an operation state has made a transition to a first state in which the electronic pen is pressing the pen sensor, and the pen pressure calculating section calculates the pen pressure value as a first value.

In addition, in the sensor controller according to a twenty-first aspect of the present disclosure, the pen pressure calculating section calculates a movement speed of the electronic pen with respect to the pen sensor from the position signal and determines a value of the first potential according to the calculated movement speed.

In addition, in the sensor controller according to a twenty-second aspect of the present disclosure, the pen pressure calculating section sets the value of the first potential to a value of a third potential when the movement speed is equal to or higher than a speed threshold value, and the pen pressure calculating section sets the value of the first potential to a value of a fourth potential higher than the third potential when the movement speed is lower than the speed threshold value.

In addition, in the sensor controller according to a twenty-third aspect of the present disclosure, the pen pressure calculating section determines the value of the first potential such that the value of the first potential is proportional to the movement speed.

In addition, in the sensor controller according to a twenty-fourth aspect of the present disclosure, the pen pressure calculating section calculates a movement speed of the electronic pen with respect to the pen sensor from the position signal and determines the first value according to the calculated movement speed.

In addition, in the sensor controller according to a twenty-fifth aspect of the present disclosure, the pen pressure calculating section calculates the pen pressure value when a predetermined condition is not satisfied, and the predetermined condition is a condition that a time elapsed since a previous calculation of the pen pressure value is less than a reference time and a distance traveled by the electronic pen since the previous calculation of the pen pressure value is less than a reference distance.

In addition, in the sensor controller according to a twenty-sixth aspect of the present disclosure, when the predetermined condition is satisfied, the pen pressure calculating section performs wait processing of making processing wait for a wait time in a case where the wait processing has not been performed after a previous determination for the predetermined condition, and the pen pressure calculating section calculates the pen pressure value in a case where the wait processing has been performed after the previous determination for the predetermined condition.

In addition, an electronic pen according to a twenty-seventh aspect of the present disclosure is an electronic pen for indicating a position on a pen sensor, the electronic pen including a pen tip that has an electrode configured to transmit and receive signals to and from the pen sensor and is capable of being housed in a housing member, and a pen controller configured to transmit and receive the signals to and from the pen sensor via the electrode, determine a housing state of the pen tip with respect to the housing member, make a notification to the pen sensor when determining that the pen tip is housed in the housing member, and stop the signal transmission according to a response to the notification, the response being transmitted from the pen sensor.

In addition, in the electronic pen according to a twenty-eighth aspect of the present disclosure, the pen controller makes a notification to the pen sensor when the housing state has changed from a state in which the pen tip is housed in the housing member to a state in which the pen tip is not housed in the housing member, and the pen controller starts the signal transmission according to a response to the notification, the response being transmitted from the pen sensor.

In addition, the electronic pen according to a twenty-ninth aspect of the present disclosure further includes the housing member as a casing in a tubular shape, and a protruding and retracting member configured to enable the pen tip to be protruded from and retracted into an opening on one side of the casing.

In addition, in the electronic pen according to a thirtieth aspect of the present disclosure, the protruding and retracting member is a knock mechanism configured to enable the pen tip to be protruded from and retracted into the opening on the one side of the casing, the electronic pen further includes a switch member configured to be changed in state according to a sliding movement of a sliding member configured to be slidingly moved in a manner interlocked with a knock operation of the knock mechanism, and the pen controller determines the housing state on the basis of the state of the switch member.

In addition, in the electronic pen according to a thirty-first aspect of the present disclosure, the protruding and retracting member includes a protruding and retracting mechanism configured to enable the pen tip to be protruded from and retracted into the opening on the one side of the casing by a rotation of a member coupled to the casing in a manner of being rotatable with a center line of the casing as a rotational axis of the member, the electronic pen further includes a detecting member configured to be changed in state according to a rotational movement of the protruding and retracting mechanism, the rotational movement being interlocked with the rotation of the member rotatably coupled to the casing, and the pen controller determines the housing state on the basis of the state of the detecting member.

In addition, in the electronic pen according to a thirty-second aspect of the present disclosure, the housing member is a cap detachably fitted to the casing in such a manner as to cover the pen tip, the casing being provided with the pen tip.

In addition, in the electronic pen according to a thirty-third aspect of the present disclosure, the housing member is a casing of an electronic apparatus having a hole portion into which the pen tip is insertable.

In addition, the electronic pen according to a thirty-fourth aspect of the present disclosure further includes a detecting member configured to detect a change in an electric field, a magnetic field, or a capacitance of a space including the pen tip, in which the pen controller determines the housing state on the basis of a result of the detection of the detecting member.

In addition, the electronic pen according to a thirty-fifth aspect of the present disclosure further includes a detecting member configured to detect a change in an electric conduction state between the pen tip and the housing member, in which the pen controller determines the housing state on the basis of a result of the detection of the detecting member.

In addition, in the electronic pen according to a thirty-sixth aspect of the present disclosure, the electrode is a first electrode, the electronic pen further includes a second electrode that transmits and receives the signals to and from the pen sensor, is capable of receiving a signal transmitted from the first electrode, and is different from the first electrode, and the pen controller determines whether or not the pen tip is housed in the housing member on the basis of an amount of change in a signal level of the signal transmitted from the first electrode to the second electrode.

According to the present disclosure, the sensor controller can calculate the pen pressure of the electronic pen on the pen sensor with high accuracy.

### BRIEF DESCRIPTION OF THE SEVERAL VIEWS OF THE DRAWINGS

FIG. 1 is a diagram illustrating an example of a position detection system according to a first embodiment;

FIG. 2 is a diagram illustrating an example of a specific configuration of an electronic pen according to the first embodiment;

FIG. 3 is a diagram illustrating an example of functional configurations of a sensor controller according to the first embodiment;

FIG. 4 is a graph illustrating an example of relation between amounts of change in level of a position signal and a pen pressure value in the first embodiment;

FIG. 5 is a graph illustrating another example of the relation between amounts of change in the level of the position signal and the pen pressure value in the first embodiment;

FIG. 6 is a flowchart illustrating an example of a flow of a series of processing by an electronic apparatus according to the first embodiment;

FIG. 7 is a diagram illustrating an example of a specific configuration of an electronic apparatus according to a second embodiment;

FIG. 8 is a graph illustrating an example of relation between amounts of change in levels of a position signal and a pen pressure signal and a pen pressure value in the second embodiment;

FIG. 9 is a flowchart illustrating an example of a flow of a series of processing by the electronic apparatus according to the second embodiment;

FIG. 10A is a sectional view of a position detection system according to a third embodiment, the sectional view being taken along a line X-X;

FIG. 10B is a sectional view in a case where an electronic pen is inclined with respect to an electronic apparatus in the position detection system illustrated in FIG. 10A;

FIG. 11 is a graph illustrating an example of relation between amounts of change in level of an uplink signal and a pen pressure value in a case where the inclination of the electronic pen is large in the third embodiment;

FIG. 12A is a diagram illustrating an example of a signal level distribution in a case where an electronic pen is not in contact with an electronic apparatus and has a small inclination with respect to the electronic apparatus in a fourth embodiment;

FIG. 12B is a diagram illustrating an example of a signal level distribution in a case where the electronic pen is in contact with the electronic apparatus and has a small inclination with respect to the electronic apparatus in the fourth embodiment;

FIG. 12C is a diagram illustrating an example of a signal level distribution in a case where the electronic pen is not in contact with the electronic apparatus and has a large inclination with respect to the electronic apparatus in the fourth embodiment;

FIG. 12D is a diagram illustrating an example of a signal level distribution in a case where the electronic pen is in contact with the electronic apparatus and has a large inclination with respect to the electronic apparatus in the fourth embodiment;

FIG. 13 is a flowchart illustrating an example of a flow of a series of processing by the electronic apparatus according to the fourth embodiment;

FIG. 14 is a flowchart illustrating an example of a flow of a series of processing by an electronic apparatus according to a fifth embodiment;

FIG. 15 is a flowchart illustrating an example of a flow of a series of processing by an electronic apparatus according to a sixth embodiment;

FIG. 16A is a diagram illustrating a state in which a pen tip of a knock type electronic pen according to a seventh embodiment is housed within a hollow portion of a casing;

FIG. 16B is a diagram illustrating a state in which the pen tip of the knock type electronic pen according to the seventh embodiment is protruded from an opening portion of the casing;

FIG. 17A is a diagram illustrating a state in which a pen tip of a rotary type electronic pen according to the seventh embodiment is housed within the hollow portion of the casing;

FIG. 17B is a diagram illustrating a state in which the pen tip of the rotary type electronic pen according to the seventh embodiment is protruded from the opening portion of the casing;

FIG. 18A is a diagram illustrating an example of a configuration of a cap type electronic pen according to the seventh embodiment;

FIG. 18B is a diagram illustrating another example of the configuration of the cap type electronic pen according to the seventh embodiment;

FIG. 18C is a diagram illustrating an example of a configuration of an electronic pen and an electronic apparatus capable of housing the electronic pen according to the seventh embodiment; and

FIG. 19 is a flowchart illustrating an example of a flow of a series of processing by the electronic pen according to the seventh embodiment.

### DETAILED DESCRIPTION

Embodiments (hereinafter each referred to as a “first embodiment,” a “second embodiment,” a “third embodiment,” a “fourth embodiment,” a “fifth embodiment,” a “sixth embodiment,” or a “seventh embodiment”) of the present disclosure will hereinafter be described with reference to the accompanying drawings. In order to facilitate understanding of the description, identical constituent elements and steps in the drawings are denoted by the same reference symbols where possible, and repeated description thereof will be omitted.

### First Embodiment

A first embodiment will first be described.

### General Configuration

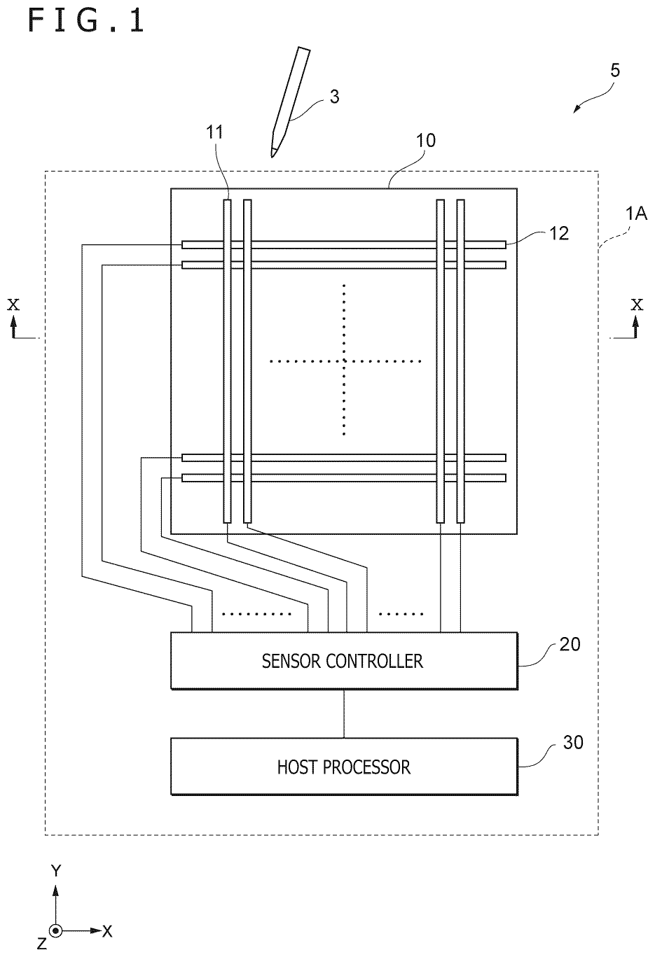

FIG. 1 is a diagram illustrating an example of a specific configuration of a position detection system 5 according to the first embodiment. As illustrated in FIG. 1, the position detection system 5 includes an electronic apparatus 1A and an electronic pen 3. The electronic apparatus 1A is a computer owned by a user. The electronic apparatus 1A may be, for example, a tablet, a smart phone, a personal computer, or the like. The electronic apparatus 1A includes, for example, a pen sensor 10, a sensor controller 20, a host processor 30, and a display panel 40. Though not illustrated, the electronic apparatus 1A includes a memory, a communication module, and the like. Incidentally, in FIG. 1, the electronic pen 3 is an active capacitance (AES) type stylus. The user can write a drawing or a character on the display panel 40 of the electronic apparatus 1A by moving a pen tip of the electronic pen 3 as a pen type pointing device while pressing the pen tip against the display panel 40 of the electronic apparatus 1A. Incidentally, while the electronic pen 3 is an active type touch pen in the first embodiment, the electronic pen 3 may be a non-active type touch pen. In addition, while the electronic pen 3 is configured to be able to perform two-way communication with the electronic apparatus 1A in the first embodiment, the electronic pen 3 is not limited to this, but may be configured to be able to perform one-way communication in only a direction from the electronic pen 3 to the electronic apparatus 1A. In addition, in the first embodiment, an upward direction, a rightward direction, and a frontward direction when the display panel 40 of the electronic apparatus 1A is viewed from the front are respectively defined as a Y-axis direction, an X-axis direction, and a Z-axis direction.

The pen sensor 10 is, for example, a capacitive type sensor formed by arranging a plurality of detection electrodes in a planar shape. The pen sensor 10 is provided to overlap a display region of the display panel 40 in a plan view, and detects the position of the electronic pen 3. The pen sensor 10 includes, for example, a plurality of linear detection electrodes 11 for detecting a position on an X-axis of a sensor coordinate system and a plurality of linear detection electrodes 12 for detecting a position on a Y-axis of the sensor coordinate system. The detection electrodes 11 and 12 may be formed of a transparent conductive material including indium tin oxide (ITO) or may be formed by a wire mesh sensor. Incidentally, the pen sensor 10 may be a self-capacitance type sensor obtained by arranging block-shaped electrodes in a two-dimensional lattice manner, in place of the above-described mutual capacitance type sensor. In addition, while the pen sensor 10 is a capacitive type sensor in the present embodiment, the pen sensor 10 is not limited to this, but may be a loop coil antenna used in an electromagnetic resonance (EMR) system, for example.

The sensor controller 20 controls operations of position detection and pen pressure detection for the electronic pen 3 by the pen sensor 10. In addition, the sensor controller 20 performs reception and transmission control on the pen sensor 10, thereby performing two-way communication between the electronic pen 3 and the sensor controller 20. In addition, the sensor controller 20 communicates with the host processor 30. Incidentally, the sensor controller 20 may perform one-way communication in which the sensor controller 20 receives a signal transmitted from the electronic pen 3 via the pen sensor 10 and does not transmit any signal to the electronic pen 3 via the pen sensor 10. In addition, the sensor controller 20 includes, for example, a communicating device, a storage device, a central processing unit (CPU), and a memory. The sensor controller 20 includes various functional configurations to be described later when the CPU executes a predetermined program stored in the memory, the storage device, or the like. The communicating device is constituted by a communication interface or the like for communicating with an external device. The storage device is constituted by a hard disk or the like and stores various programs and various kinds of information necessary to perform processing in the sensor controller 20 and information regarding processing results.

The host processor 30 is constituted by an arithmetic processing device including a CPU, a graphics processing unit (GPU), and a micro-processing unit (MPU). The host processor 30 plays a role of executing an operating system of the electronic apparatus 1A, various applications such as drawing software, and the like by executing programs stored in a memory not illustrated. The drawing software includes functions of generating stroke data on the basis of coordinates sequentially supplied from the sensor controller 20, performing rendering, and displaying resultant data on a display. The drawing software also includes a function of adjusting the result of the rendering on the basis of data such as a pen pressure value supplied from the sensor controller 20 (for example, a function of adjusting a line width according to the pen pressure value).

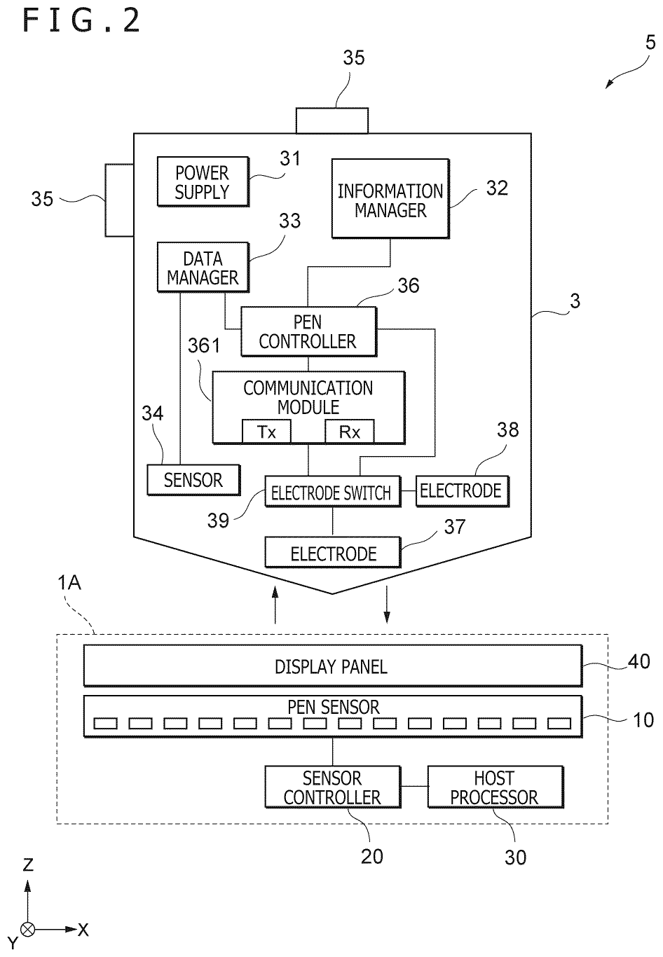

The display panel 40 is configured to be able to display “display targets” including text, an image, a moving image, and the like. Specifically, the display panel 40 is able to display a monochrome image or a color image and is constituted by, for example, a liquid crystal panel, an organic electro-luminescence (EL) panel, electronic paper, a quantum dot panel, or the like. In addition, the liquid crystal panel may be of any of a backlight type, a mini light emitting diode (LED) type, or a micro LED type. The display panel 40 responds to a detection of the electronic pen 3 by the pen sensor 10, and displays a display target according to control of the host processor 30. As illustrated in FIG. 2, the display panel 40 is provided above the pen sensor 10 (in the Z-axis direction).

A specific configuration of the electronic pen 3 will be described with reference to FIG. 2. FIG. 2 is a diagram illustrating an example of a specific configuration of the electronic pen 3 according to the first embodiment. As illustrated in FIG. 2, the electronic pen 3 includes, for example, a power supply 31, an information manager 32, a data manager 33, a sensor 34, buttons 35, a pen controller 36, a communication module 361, electrodes 37 and 38, and an electrode switch 39. The electronic pen 3 has the buttons 35 and the electrodes 37 and 38 provided on a surface of a casing and has the power supply 31, the information manager 32, the data manager 33, the sensor 34, the communication module 361, the electrode switch 39, and the pen controller 36 provided within the casing.

The power supply 31 is a freely-selected kind of power supply that supplies power to the electronic pen 3, the power supply being a battery or a power supply capable of storing electricity.

The information manager 32 stores pen function information regarding the electronic pen 3. The pen function information includes, for example, information regarding predetermined functions of the electronic pen 3 and setting information regarding settings of the electronic pen 3, which are adjustable by the user. The information manager 32 updates the setting information each time the user changes a setting of the electronic pen 3 such as a color of the electronic pen 3 or a line width of the electronic pen 3.

The data manager 33 manages operation data of the electronic pen 3. The operation data indicates operation states of the electronic pen 3 such as the pressure of a distal end portion of the electronic pen 3 and a rotational state and a battery level of the electronic pen 3. The operation data is generated by the sensor 34. The sensor 34 includes a pressure sensor configured to sense the pressure applied to the distal end portion of the electronic pen 3 and a rotation sensor configured to sense rotation of the electronic pen 3.

The pen controller 36 controls operation of the communication module 361 and the electrode switch 39 in two-way communication with the sensor controller 20 of the electronic apparatus 1A. Specifically, by controlling the electrode switch 39, the pen controller 36 sets the electrodes 37 and 38 in a transmission mode of transmitting the pen function information and the operation data to the sensor controller 20 via the communication module 361 and the electrode 37.

The communication module 361 is a module that performs two-way communication with the electronic apparatus 1A. The communication module 361 includes a transmitting (TX) circuit and a receiving (RX) circuit that communicate with the electronic apparatus 1A via at least one of the electrodes 37 and 38. The electrodes 37 and 38 are used to communicate with the electrodes of the pen sensor 10 of the electronic apparatus 1A.

The electrodes 37 and 38 are arranged at respective different positions on the casing of the electronic pen 3. Specifically, the electrode 37 is provided at the pen tip of the electronic pen 3. The electrode 37 is used for indication of a coordinate value of the electronic pen 3 on the display panel 40 and communication with the sensor controller 20. The electrode 38 is provided to be separated from the electrode 37, that is, above the electrode 37 and below a holding portion where the user holds the electronic pen 3. In addition, the electrode 38 is a ring electrode formed in an annular shape and is provided to cover a periphery of the electronic pen 3. The electrode 38 is used for measurement of a posture value of the electronic pen 3. The posture value includes, for example, an inclination value indicating an inclination of the electronic pen 3 and an orientation value indicating an orientation of the electronic pen 3 on the display panel 40. The orientation value is a value indicating the orientation of the pen tip of the electronic pen 3 when the display panel 40 is viewed from the Z-axis direction. The inclination value is an angle of the electronic pen 3 in the Z-axis direction with respect to a display surface of the display panel 40.

The electrode switch 39 is a switch that switches the operation of the electrodes 37 and 38 between a transmission mode and a reception mode.

### Functional Configuration

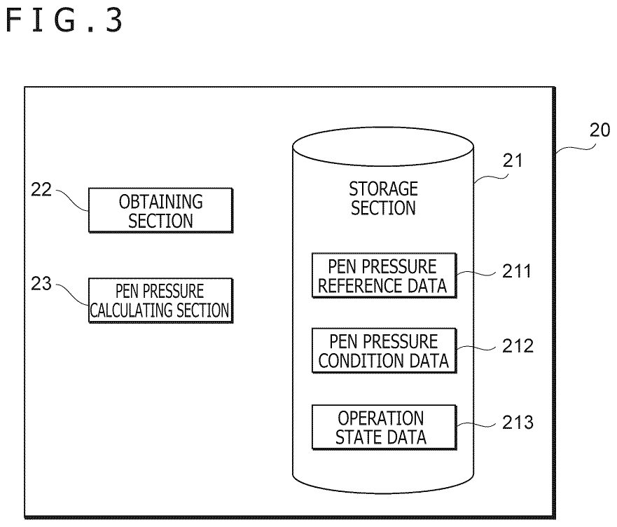

Functional configurations of the sensor controller 20 of the electronic apparatus 1A will next be described with reference to FIG. 3. FIG. 3 is a diagram illustrating an example of functional configurations of the sensor controller 20 according to the first embodiment. As illustrated in FIG. 3, the sensor controller 20 includes, for example, a storage section 21, an obtaining section 22, and a pen pressure calculating section 23 as functional configurations thereof. Incidentally, functional sections other than the storage section 21 are implemented by the CPU of the sensor controller 20 executing a program stored in the storage device of the sensor controller 20 or the like.

The storage section 21 is a functional configuration that stores various values and various conditions used by the pen pressure calculating section 23 in calculating a pen pressure, and the like. Specifically, the storage section 21 stores pen pressure reference data 211, pen pressure condition data 212, and operation state data 213.

The pen pressure reference data 211 is data used by the pen pressure calculating section 23 in calculating the pen pressure. Specifically, the pen pressure reference data 211 includes a value of a first potential, a value of a second potential, a value of a predetermined time representing a cycle for determining a rise and a fall in the potential of a position signal, a first value, and a second value. The first potential is a potential for determining whether or not an operation state has made a transition to a first state, which is a state in which the electronic pen 3 is pressing the pen sensor 10. The second potential is a potential for determining whether or not the operation state has made a transition to a second state, which is a state in which the electronic pen 3 is separated from the pen sensor 10. Incidentally, the second potential may be a potential same as the first potential, or may be a potential different from the first potential. The predetermined time is a cycle for determining a rise and a fall in the potential of the position signal. The first value is a set value of the pen pressure value in the first state. The second value is a set value of the pen pressure value in the second state and is a value different from the first value. Incidentally, the pen pressure reference data 211 may store a first signal level and a second signal level in place of the first potential and the second potential, respectively. A signal level is a level having correlation to a reception strength of the position signal and may be, for example, a value of a potential, a value of a current, a value of electric power, a digital value of a digital signal, or the like.

The pen pressure condition data 212 is data regarding conditions used when the pen pressure calculating section 23 determines the operation state indicating whether the electronic pen 3 is pressing the pen sensor 10 or whether the electronic pen 3 is separated from the pen sensor 10. Incidentally, an example of the conditions indicated by the pen pressure condition data 212 will be described later, and therefore, a description thereof will be omitted here.

The operation state data 213 is data indicating a present operation state. The operation state data 213 indicates whether the present operation state is the first state or the second state.

The obtaining section 22 obtains a position signal indicating the position of the electronic pen 3 from the pen sensor 10. Specifically, the obtaining section 22 obtains, from the pen sensor 10, each of a position signal transmitted from the detection electrodes 11 and a position signal transmitted from the detection electrodes 12.

The pen pressure calculating section 23 calculates the pen pressure value regarding the pen pressure of the electronic pen 3 on the pen sensor 10 on the basis of a change in the potential of the position signal obtained by the obtaining section 22. Specifically, the pen pressure calculating section 23 refers to the potential of the position signal obtained by the obtaining section 22 and the pen pressure reference data 211 and the pen pressure condition data 212 stored in the storage section 21. When the potential of the position signal has risen by the first potential or more within the predetermined time, the pen pressure calculating section 23 determines that the operation state has made a transition to the first state. Then, the pen pressure calculating section 23 calculates the pen pressure value as the first value. In addition, when the potential of the position signal has fallen by the second potential or more within the predetermined time, the pen pressure calculating section 23 determines that the operation state has made a transition to the second state. Then, the pen pressure calculating section 23 calculates the pen pressure value as the second value. In addition, when the potential of the position signal does not meet the above-described conditions, the pen pressure calculating section 23 determines that the operation state has not changed, and the pen pressure calculating section 23 maintains the pen pressure value. The pen pressure calculating section 23 stores the determined present operation state in the operation state data 213 in the storage section 21. Incidentally, at a time of determining a rise and a fall in the potential of the position signal, the pen pressure calculating section 23 determines that the potential has risen or fallen, when both the position signal transmitted from the detection electrodes 11 and the position signal transmitted from the detection electrodes 12 satisfy the condition. Incidentally, while the pen pressure calculating section 23 uses the potential in calculating the pen pressure value in the first to seventh embodiments, the pen pressure calculating section 23 is not limited to only using the potential in calculating the pen pressure value. The pen pressure calculating section 23 may use the above-described signal level in calculating the pen pressure value in place of the potential.

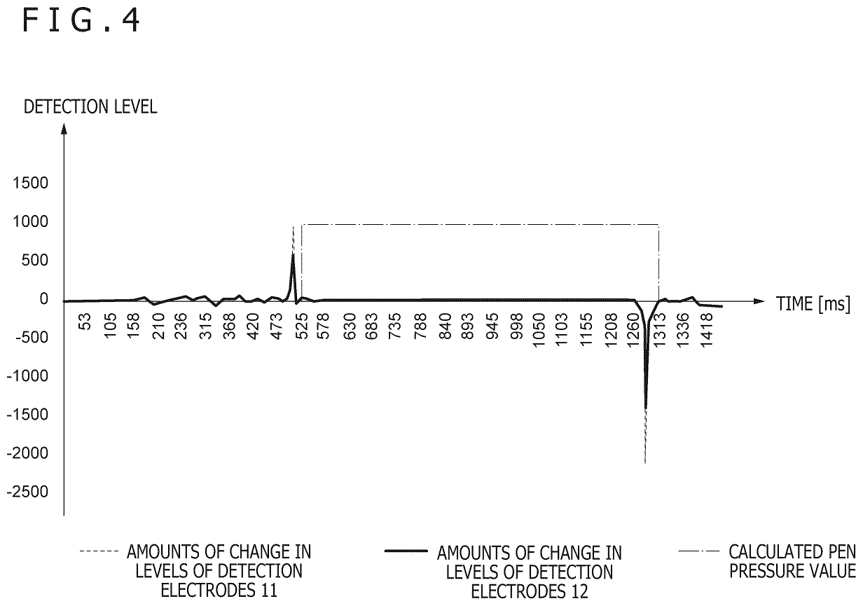

Here, an example of the calculation of the pen pressure by the pen pressure calculating section 23 will be described with reference to FIG. 4. FIG. 4 is a graph illustrating an example of relation between amounts of change in the level of the position signal and the pen pressure value in the first embodiment. In FIG. 4, an axis of ordinates indicates detection levels obtained by conversion of the potentials into a common scale by a predetermined conversion equation. In addition, in FIG. 4, an axis of abscissas indicates elapsed time [ms]. The graph illustrated in FIG. 4 illustrates data indicating a difference in detection levels of the detection electrodes 11 from previous ones, data indicating a difference in detection levels of the detection electrodes 12 from previous ones, and data indicating the level of the pen pressure value. In addition, suppose that, in FIG. 4, detection levels associated with the first potential and the second potential are each 200, the predetermined time is 10 ms, the first value is 1000 and the second value is 0. Incidentally, an amount of change in the level is an amount indicating how much the value of the level has changed per unit time. Specifically, an amount of change in the level is, for example, a rate of increase or a rate of decrease in the level, a differential value obtained by differentiating the value of the level with respect to time, or the like.

At an elapsed time of 0 ms, the obtaining section 22 obtains the potential from the position signal. From the elapsed time of 0 ms to an elapsed time of 473 ms, amounts of change in the detection levels of the detection electrodes 11 and 12 (differences from the previous ones) both indicate approximately 0. From the elapsed time of 0 ms to the elapsed time of 473 ms, the pen pressure calculating section 23 determines the detection levels each time the predetermined time of 10 ms has passed, determines that the detection levels have not varied by 200 or more and thus the operation state remains the second state, and calculates the pen pressure value by maintaining the pen pressure value at 0 as it is. The host processor 30 determines that the electronic pen 3 is separated from the pen sensor 10, according to the pen pressure value of 0 transmitted from the pen pressure calculating section 23, and the host processor 30 performs an operation of display control on the display panel 40.

At an elapsed time of 500 ms, an amount of change in the detection levels of the detection electrodes 11 indicates approximately 1000. In addition, at the elapsed time of 500 ms, an amount of change in the detection levels of the detection electrodes 12 indicates approximately 700. At the elapsed time of 500 ms, the pen pressure calculating section 23 determines that the detection levels have risen by 200 or more and thus the operation state has made a transition from the second state to the first state, and calculates the pen pressure value as 1000.

At an elapsed time of 525 ms, the pen pressure calculating section 23 corrects the pen pressure value to 1000 as the calculated value, and transmits the pen pressure value after being corrected to the host processor 30. The host processor 30 determines that the electronic pen 3 is pressing the pen sensor 10 with a force corresponding to the pen pressure value of 1000, according to the pen pressure value of 1000 transmitted from the pen pressure calculating section 23, and the host processor 30 performs an operation of display control on the display panel 40.

From an elapsed time of 530 ms to an elapsed time of 1260 ms, amounts of change in the detection levels of the detection electrodes 11 and 12 both indicate approximately 0. From the elapsed time of 530 ms to the elapsed time of 1260 ms, the pen pressure calculating section 23 determines the detection levels each time the predetermined time of 10 ms has passed, determines that the detection levels have not varied by 200 or more and thus the operation state remains the first state, and maintains the pen pressure value at 1000 as it is.

At an elapsed time of 1290 ms, an amount of change in the detection levels of the detection electrodes 11 indicates approximately −2000. In addition, at the elapsed time of 1290 ms, an amount of change in the detection levels of the detection electrodes 12 indicates approximately −1300. At the elapsed time of 1290 ms, the pen pressure calculating section 23 determines that the detection levels have fallen by 200 or more and thus the operation state has made a transition from the first state to the second state, and calculates the pen pressure value as 0.

At an elapsed time of 1313 ms, the pen pressure calculating section 23 corrects the pen pressure value to 0 as the calculated value, and transmits the pen pressure value after being corrected to the host processor 30. The host processor 30 determines that the electronic pen 3 is separated from the pen sensor 10, according to the pen pressure value of 0 transmitted from the pen pressure calculating section 23, and the host processor 30 performs an operation of display control on the display panel 40.

### Flow of Series of Operations

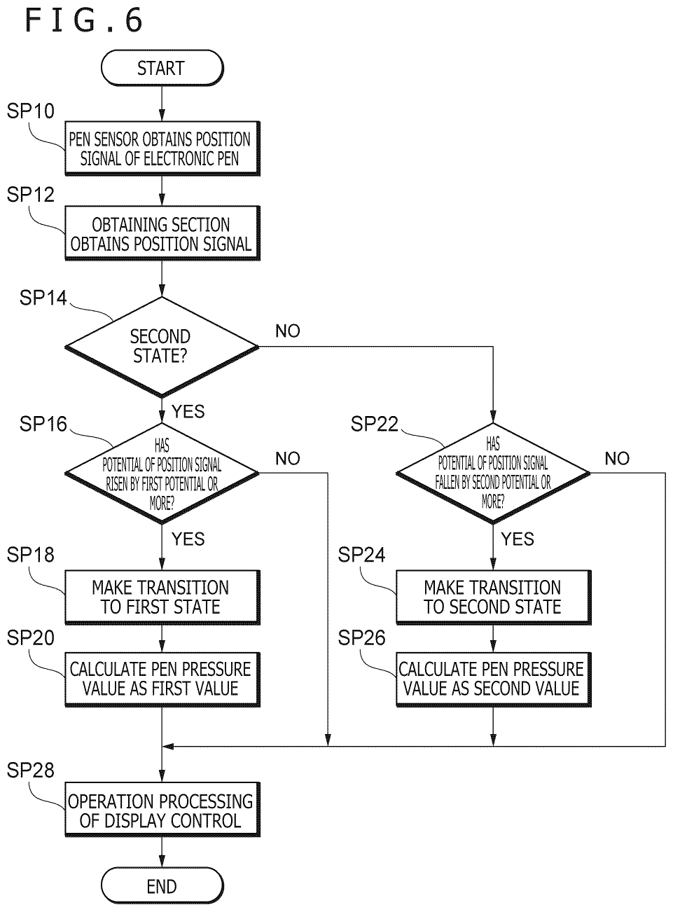

The functional configurations of the sensor controller 20 have been described above. A flow of specific processing in the electronic apparatus 1A will next be described in detail. FIG. 6 is a flowchart illustrating an example of a flow of a series of processing by the electronic apparatus 1A. Incidentally, the contents and order of processing of the following steps can be changed as appropriate.

### (Step SP10)

Via the pen sensor 10, the electronic apparatus 1A obtains, from the electronic pen 3, the position signal indicating a position indicated by the electronic pen 3 on the pen sensor 10. The processing then proceeds to the processing of step SP12.

### (Step SP12)

Via the obtaining section 22, the electronic apparatus 1A obtains the position signal transmitted from the detection electrodes 11 and 12 of the pen sensor 10. The processing then proceeds to the processing of step SP14.

### (Step SP14)

Via the pen pressure calculating section 23, the electronic apparatus 1A refers to the operation state data 213 in the storage section 21 and determines whether or not the present operation state is the second state. Then, when the determination is a positive determination, the processing proceeds to the processing of step SP16. When the determination is a negative determination, on the other hand, the electronic apparatus 1A determines that the present operation state is the first state, and the processing proceeds to the processing of step SP22.

### (Step SP16)

Via the pen pressure calculating section 23, the electronic apparatus 1A determines whether or not the potential of the position signal has risen by the first potential or more during the predetermined time. Incidentally, via the pen pressure calculating section 23, the electronic apparatus 1A may determine whether or not the potential of the position signal has risen by the first potential or more from a previously obtained potential of the position signal. Then, when the determination is a positive determination, the processing proceeds to the processing of step SP18. When the determination is a negative determination, on the other hand, the processing proceeds to the processing of step SP28.

### (Step SP18)

Via the pen pressure calculating section 23, the electronic apparatus 1A determines that the operation state has made a transition from the second state to the first state. Via the pen pressure calculating section 23, the electronic apparatus 1A updates the operation state data 213 in the storage section 21 in such a manner as to indicate that the present operation state is the first state. The processing then proceeds to the processing of step SP20.

### (Step SP20)

Via the pen pressure calculating section 23, the electronic apparatus 1A calculates the pen pressure value as the first value. In addition, via the pen pressure calculating section 23, the electronic apparatus 1A transmits the calculated pen pressure value to the host processor 30. The processing then proceeds to the processing of step SP28.

### (Step SP22)

Via the pen pressure calculating section 23, the electronic apparatus 1A determines whether or not the potential of the position signal has fallen by the second potential or more during the predetermined time. Incidentally, via the pen pressure calculating section 23, the electronic apparatus 1A may determine whether or not the potential of the position signal has fallen by the second potential or more from a previously obtained potential of the position signal. Then, when the determination is a positive determination, the processing proceeds to the processing of step SP24. When the determination is a negative determination, on the other hand, the processing proceeds to the processing of step SP28.

### (Step SP24)

Via the pen pressure calculating section 23, the electronic apparatus 1A determines that the operation state has made a transition from the first state to the second state. Via the pen pressure calculating section 23, the electronic apparatus 1A updates the operation state data 213 in the storage section 21 in such a manner as to indicate that the present operation state is the second state. The processing then proceeds to the processing of step SP26.

### (Step SP26)

Via the pen pressure calculating section 23, the electronic apparatus 1A calculates the pen pressure value as the second value. In addition, via the pen pressure calculating section 23, the electronic apparatus 1A transmits the calculated pen pressure value to the host processor 30. The processing then proceeds to the processing of step SP28.

### (Step SP28)

Via the host processor 30, the electronic apparatus 1A performs an operation of display control on the display panel 40 according to the pen pressure indicated by the pen pressure value transmitted from the pen pressure calculating section 23. The series of processing illustrated in FIG. 6 is then ended.

### Effects

As described above, in the first embodiment, the sensor controller 20 includes the obtaining section 22 that obtains the position signal indicating the position of the electronic pen 3 from the pen sensor 10, which detects the position of the electronic pen 3. In addition, the sensor controller 20 further includes the pen pressure calculating section 23 that calculates the pen pressure value regarding the pen pressure of the electronic pen 3 on the pen sensor 10 based on a change in the signal level of the position signal obtained by the obtaining section 22. This configuration therefore reduces an effect of variation in the signal level of the position signal due to manufacturing variation in the electronic pen 3 or the like. Hence, the sensor controller 20 can calculate the pen pressure of the electronic pen 3 on the pen sensor 10 with high accuracy.

In addition, in the first embodiment, when the potential of the position signal has risen by the first potential or more within the predetermined time, the pen pressure calculating section 23 determines that the operation state has made a transition to the first state in which the electronic pen 3 is pressing the pen sensor 10, and the pen pressure calculating section 23 calculates the pen pressure value as the first value. Here, the signal level is a potential. Hence, because the sensor controller 20 calculates the pen pressure value according to an amount of rise in the position signal, the sensor controller 20 can determine a pressing of the electronic pen 3 against the pen sensor 10 with a simple configuration and with high accuracy, and calculate the pen pressure value according to the pressing.

In addition, in the first embodiment, when the potential of the position signal has fallen by the second potential or more within the predetermined time, the pen pressure calculating section 23 determines that the operation state has made a transition to the second state in which the electronic pen 3 is separated from the pen sensor 10, and the pen pressure calculating section 23 calculates the pen pressure value as the second value different from the first value. Hence, because the sensor controller 20 calculates the pen pressure value according to an amount of fall in the position signal, the sensor controller 20 can determine a separation of the electronic pen 3 from the pen sensor 10 with a simple configuration and with high accuracy, and calculate the pen pressure value according to the separation.

### Second Embodiment

A second embodiment will next be described.

### General Configuration

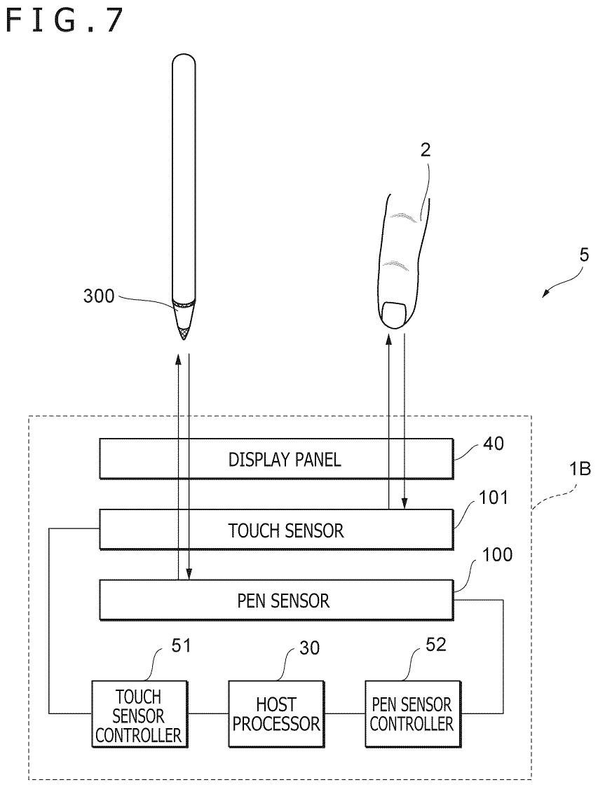

FIG. 7 is a diagram illustrating an example of a specific configuration of an electronic apparatus 1B according to the second embodiment. As illustrated in FIG. 7, the electronic apparatus 1B according to the second embodiment includes a pen sensor 100, a touch sensor 101, a touch sensor controller 51, a pen sensor controller 52, a host processor 30, and a display panel 40. Incidentally, the display panel 40 and the host processor 30 are similar to those of the first embodiment, and a description thereof will therefore be omitted.

An electronic pen 300 is a stylus including a resonance circuit used in the EMR system. The electronic pen 300 receives a magnetic field generated from the pen sensor 100, drives the resonance circuit according to the received magnetic field, and transmits a position signal indicating a position indicated by the electronic pen 300 to the pen sensor 100. The electronic pen 300 also includes a pen pressure sensor that detects a pen pressure applied to a pen tip of the electronic pen 300. The pen pressure sensor includes a capacitor whose capacitance is variable according to the pen pressure and a coil. The electronic pen 300 transmits a pen pressure signal indicating the pen pressure of the electronic pen 300 to the pen sensor 100 according to the driving of the resonance circuit.

The touch sensor 101 is similar to the pen sensor 10. The touch sensor 101 is, for example, a capacitive type sensor formed by arranging a plurality of detection electrodes 11 and 12 in a planar shape. The touch sensor 101 detects a position indicated by a finger 2 of a user. It is to be noted that, while the touch sensor 101 is a sensor of an “external type” that is externally attached to the display panel 40 in the present embodiment, the touch sensor 101 is not limited to this. The touch sensor 101 may be a sensor of a “built-in type” (an on-cell type or an in-cell type when further classified) that is formed integrally with the display panel 40.

The pen sensor 100 is a loop coil antenna used in the EMR system. The pen sensor 100 includes a plurality of loop coils for detecting a position in the X-axis direction and a plurality of loop coils for detecting a position in the Y-axis direction. The pen sensor 100 detects the position indicated by the electronic pen 300, by generating a magnetic field from the coil antenna and receiving the position signal transmitted from the resonance circuit provided in the electronic pen 300. In addition, the pen sensor 100 detects the pen pressure applied to the pen sensor 100 by the electronic pen 300, by generating a magnetic field from the coil antenna and receiving the pen pressure signal transmitted from the resonance circuit provided in the electronic pen 300.

The touch sensor controller 51 controls the operations of position detection and pen pressure detection for the finger 2 by the touch sensor 101. In addition, the touch sensor controller 51 communicates with the host processor 30.

The pen sensor controller 52 controls the operations of position detection and pen pressure detection for the electronic pen 300 by the pen sensor 100. In addition, the pen sensor controller 52 controls the transmission of a signal to the electronic pen 300 by the pen sensor 100 and the reception of the position signal and the pen pressure signal transmitted from the resonance circuit driven by reception of the signal transmitted from the pen sensor 100. The pen sensor controller 52 also communicates with the host processor 30.

Incidentally, the touch sensor controller 51 and the pen sensor controller 52 include, for example, a communicating device, a storage device, a CPU, and a memory. The touch sensor controller 51 and the pen sensor controller 52 function as various functional configurations to be described later, by the CPU executing a predetermined program stored in the memory, the storage device, or the like. The communicating device is constituted by a communication interface or the like for communicating with an external device. The storage device is constituted by a hard disk or the like and stores various programs and various kinds of information necessary to perform processing in the touch sensor controller 51 or the pen sensor controller 52 and information regarding processing results.

### Functional Configurations

Functional configurations of the pen sensor controller 52 of the electronic apparatus 1B will next be described. Incidentally, a storage section 21 is similar to that of the sensor controller 20 in the first embodiment, and therefore, a description thereof will be omitted. In addition, functional configurations of the touch sensor controller 51 are also similar to those of the sensor controller 20 in the first embodiment, and therefore, a description thereof will be omitted.

An obtaining section 22 obtains a position signal indicating the position of the electronic pen 300 from the pen sensor 100. Specifically, the obtaining section 22 obtains, from the pen sensor 100, each of a position signal transmitted from loop coils for detecting a position in the X-axis direction and a position signal transmitted from loop coils for detecting a position in the Y-axis direction. In addition, the obtaining section 22 obtains a pen pressure signal indicating the pen pressure of the electronic pen 300 from the pen sensor 100.

A pen pressure calculating section 23 calculates a pen pressure value by correcting the pen pressure indicated by the pen pressure signal obtained by the obtaining section 22 based on a change in the potential of the position signal obtained by the obtaining section 22. Specifically, the pen pressure calculating section 23 refers to the potentials of the position signal and the pen pressure signal obtained by the obtaining section 22 and pen pressure reference data 211 and pen pressure condition data 212 stored in the storage section 21. When the potential of the position signal has risen by the first potential or more within the predetermined time, the pen pressure calculating section 23 determines that the operation state has made a transition to the first state. Then, the pen pressure calculating section 23 calculates the pen pressure value by correcting the pen pressure indicated by the pen pressure signal by the first value. Specifically, the pen pressure calculating section 23 corrects the pen pressure by, for example, applying the first value to multiplication, addition, subtraction, or division for the value of the pen pressure indicated by the pen pressure signal, or substituting the first value and the value of the pen pressure indicated by the pen pressure signal into a predetermined relational equation. In addition, the pen pressure calculating section 23 may correct the pen pressure by, for example, making a magnitude comparison between the first value and the pen pressure indicated by the pen pressure signal, and selecting a larger value. In addition, the pen pressure calculating section 23 may calculate the pen pressure value as the first value.

When the potential of the position signal has fallen by the second potential or more within the predetermined time, the pen pressure calculating section 23 determines that the operation state has made a transition to the second state. Then, the pen pressure calculating section 23 calculates the pen pressure value by correcting the pen pressure indicated by the pen pressure signal by the second value. Specifically, the pen pressure calculating section 23 corrects the pen pressure by, for example, applying the second value to multiplication, addition, subtraction, or division for the value of the pen pressure indicated by the pen pressure signal, or substituting the second value and the value of the pen pressure indicated by the pen pressure signal into a predetermined relational equation. Incidentally, the pen pressure calculating section 23 may calculate the pen pressure value as the second value. In addition, when the potential of the position signal does not meet the above-described conditions, the pen pressure calculating section 23 determines that the operation state has not changed, and the pen pressure calculating section 23 maintains the pen pressure value. The pen pressure calculating section 23 stores the determined present operation state in operation state data 213 in the storage section 21.

In addition, when the pen pressure signal obtained by the obtaining section 22 indicates that the electronic pen 300 is pressing the pen sensor 100 before the pen pressure calculating section 23 determines that the operation state has made a transition from the second state to the first state, the pen pressure calculating section 23 determines that the pen pressure signal is indicating an abnormal value. When determining indication of an abnormal value, the pen pressure calculating section 23 corrects the pen pressure indicated by the pen pressure signal by the second value. Incidentally, when determining indication of an abnormal value, the pen pressure calculating section 23 may calculate the pen pressure indicated by the pen pressure signal as the second value.

In addition, when the pen pressure signal obtained by the obtaining section 22 indicates that the pen sensor 100 is separated from the electronic pen 300 before the pen pressure calculating section 23 determines that the operation state has made a transition from the first state to the second state, the pen pressure calculating section 23 determines that the pen pressure signal is indicating an abnormal value, and the pen pressure calculating section 23 maintains the pen pressure value.

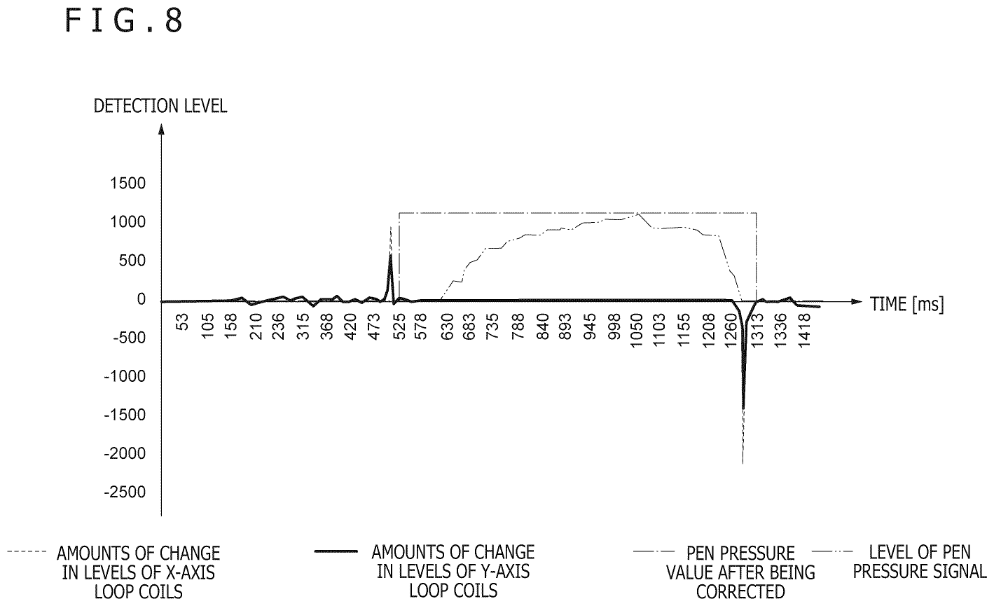

Here, an example of the calculation of the pen pressure by the pen pressure calculating section 23 in the second embodiment will be described with reference to FIG. 8. FIG. 8 is a graph illustrating an example of relation between amounts of change in the levels of the position signal and the pen pressure signal and the pen pressure value in the second embodiment. In FIG. 8, an axis of ordinates indicates detection levels obtained by conversion of the potentials into a common scale by a predetermined conversion equation. In addition, in FIG. 8, an axis of abscissas indicates elapsed time [ms]. The graph illustrated in FIG. 8 illustrates data indicating a difference in detection levels of the loop coils in the X-axis direction from previous ones, data indicating a difference in detection levels in the Y-axis direction from previous ones, data indicating the level of the pen pressure value, and the potential of the pen pressure signal. In addition, suppose that, in FIG. 8, detection levels associated with the first potential and the second potential are each 200, the predetermined time is 10 ms, the first value is 1000, the second value is 0, and the pen pressure calculating section 23 calculates the pen pressure value as the first value or the second value in calculating the pen pressure value.

As illustrated in FIG. 8, the pen pressure calculating section 23 calculates the pen pressure value as the first value earlier than the pen pressure signal indicates a pressing of the pen sensor 100 by the electronic pen 300. The pen pressure calculating section 23 then transmits the pen pressure value to the host processor 30. In addition, the pen pressure calculating section 23 calculates the pen pressure value as the second value immediately after the pen pressure signal indicates that the electronic pen 300 is separated from the pen sensor 100.

### Flow of Series of Operations

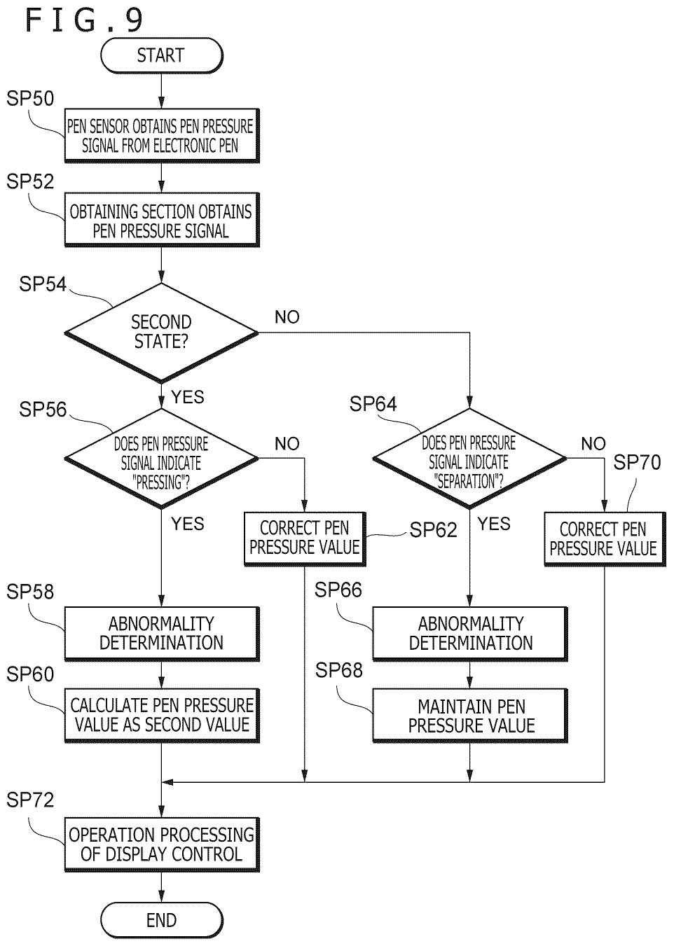

The functional configurations of the pen sensor controller 52 have been described above. A flow of specific processing in the electronic apparatus 1B will next be described in detail. FIG. 9 is a flowchart illustrating an example of a flow of a series of processing by the electronic apparatus 1B according to the second embodiment. Incidentally, the contents and order of processing of the following steps can be changed as appropriate.

### (Step SP50)

Via the pen sensor 100, the electronic apparatus 1B obtains, from the electronic pen 300, the pen pressure signal indicating the pen pressure of the electronic pen 300 on the pen sensor 100. The processing then proceeds to the processing of step SP52.

### (Step SP52)

Via the obtaining section 22, the electronic apparatus 1B obtains the position signal transmitted from the loop coils of the pen sensor 100. The processing then proceeds to the processing of step SP54.

### (Step SP54)

Via the pen pressure calculating section 23, the electronic apparatus 1B refers to the operation state data 213 in the storage section 21 and determines whether or not the present operation state is the second state. Then, when the determination is a positive determination, the processing proceeds to the processing of step SP56. When the determination is a negative determination, on the other hand, the electronic apparatus 1B determines that the present operation state is the first state, and the processing proceeds to the processing of step SP64.

### (Step SP56)

Via the pen pressure calculating section 23, the electronic apparatus 1B determines whether or not the pen pressure signal has a value indicating that the electronic pen 300 is pressing the pen sensor 100. Then, when the determination is a positive determination, the processing proceeds to the processing of step SP58. When the determination is a negative determination, on the other hand, the processing proceeds to the processing of step SP62.

### (Step SP58)

Via the pen pressure calculating section 23, the electronic apparatus 1B determines that the pen pressure signal is indicating an abnormal value. The processing then proceeds to the processing of step SP60.

### (Step SP60)

Via the pen pressure calculating section 23, the electronic apparatus 1B calculates the pen pressure value as the second value. In addition, by the pen pressure calculating section 23, the electronic apparatus 1B transmits the calculated pen pressure value to the host processor 30. The processing then proceeds to the processing of step SP72.

### (Step SP62)

Via the pen pressure calculating section 23, the electronic apparatus 1B determines that the operation state remains the second state. Then, via the pen pressure calculating section 23, the electronic apparatus 1B calculates the pen pressure value as the second value. Incidentally, via the pen pressure calculating section 23, the electronic apparatus 1B may calculate the pen pressure value by correcting the pen pressure indicated via the pen pressure signal by the second value. The processing then proceeds to the processing of step SP72.

### (Step SP64)

Via the pen pressure calculating section 23, the electronic apparatus 1B determines whether or not the pen pressure signal has a value indicating that the electronic pen 300 is separated from the pen sensor 100. Then, when the determination is a positive determination, the processing proceeds to the processing of step SP66. When the determination is a negative determination, on the other hand, the processing proceeds to the processing of step SP70.

### (Step SP66)

Via the pen pressure calculating section 23, the electronic apparatus 1B determines that the pen pressure signal is indicating an abnormal value. The processing then proceeds to the processing of step SP68.

### (Step SP68)

Via the pen pressure calculating section 23, the electronic apparatus 1B maintains the pen pressure value at a previously calculated value as it is. In addition, via the pen pressure calculating section 23, the electronic apparatus 1B transmits the calculated pen pressure value to the host processor 30. The processing then proceeds to the processing of step SP72.

### (Step SP70)

Via the pen pressure calculating section 23, the electronic apparatus 1B determines that the operation state remains the first state. Then, via the pen pressure calculating section 23, the electronic apparatus 1B calculates the pen pressure value as the first value. Incidentally, via the pen pressure calculating section 23, the electronic apparatus 1B may calculate the pen pressure value by correcting the pen pressure indicated via the pen pressure signal by the first value. The processing then proceeds to the processing of step SP72.

### (Step SP72)

Via the host processor 30, the electronic apparatus 1B performs an operation of display control on the display panel 40 according to the pen pressure indicated by the pen pressure value transmitted from the pen pressure calculating section 23. The series of processing illustrated in FIG. 9 is then ended.

### Effects

As described above, in the second embodiment, the obtaining section 22 obtains, from the pen sensor 100, the pen pressure signal that is transmitted from the electronic pen 300 to the pen sensor 100 and indicates the pen pressure of the electronic pen 300 on the pen sensor 100. In addition, the pen pressure calculating section 23 calculates the pen pressure value by correcting the pen pressure indicated by the pen pressure signal on the basis of a change in the potential of the position signal. Hence, the pen sensor controller 52 (sensor controller) can calculate the pen pressure of the electronic pen 300 on the pen sensor 100 with high accuracy also in a case where the electronic pen 300 having a function of detecting the pen pressure is used.

In addition, in the second embodiment, when the potential of the position signal has risen by the first potential or more within the predetermined time, the pen pressure calculating section 23 determines that the operation state has made a transition to the first state in which the electronic pen 300 is pressing the pen sensor 100, and the pen pressure calculating section 23 calculates the pen pressure value as the first value. In addition, when the pen pressure signal obtained by the obtaining section 22 indicates that the electronic pen 300 is pressing the pen sensor 100 before the pen pressure calculating section 23 determines that the operation state has made a transition to the first state, the pen pressure calculating section 23 determines that the pen pressure signal is indicating an abnormal value, and calculates the pen pressure value as the second value different from the first value. Here, the signal level is a potential. Hence, the pen sensor controller 52 (sensor controller) can determine an erroneous detection of the pressing of the electronic pen 300 by the pen pressure sensor as an abnormality, and can therefore calculate the pen pressure of the electronic pen 300 on the pen sensor 100 with higher accuracy.

In addition, in the second embodiment, when the potential of the position signal has fallen by the second potential or more within the predetermined time, the pen pressure calculating section 23 determines that the operation state has made a transition to the second state in which the electronic pen 300 is separated from the pen sensor 100, and the pen pressure calculating section 23 calculates the pen pressure value as the second value. In addition, when the pen pressure signal obtained by the obtaining section 22 indicates that the pen sensor 100 is separated from the electronic pen 300 before the pen pressure calculating section 23 determines that the operation state has made a transition to the second state, the pen pressure calculating section 23 determines that the pen pressure signal is indicating an abnormal value, and the pen pressure calculating section 23 maintains the pen pressure value. Hence, the pen sensor controller 52 (sensor controller) can determine an erroneous detection of the separation of the electronic pen 300 by the pen pressure sensor as an abnormality, and can therefore calculate the pen pressure of the electronic pen 300 on the pen sensor 100 with higher accuracy.

### Third Embodiment

A third embodiment will next be described.

In the first embodiment and the second embodiment, the sensor controller 20 provided in the electronic apparatus 1A or the pen sensor controller 52 provided in the electronic apparatus 1B calculates the pen pressure value. The third embodiment is different from the first embodiment and the second embodiment in that the electronic pen 3, rather than the electronic apparatuses 1A and 1B, calculates the pen pressure value.

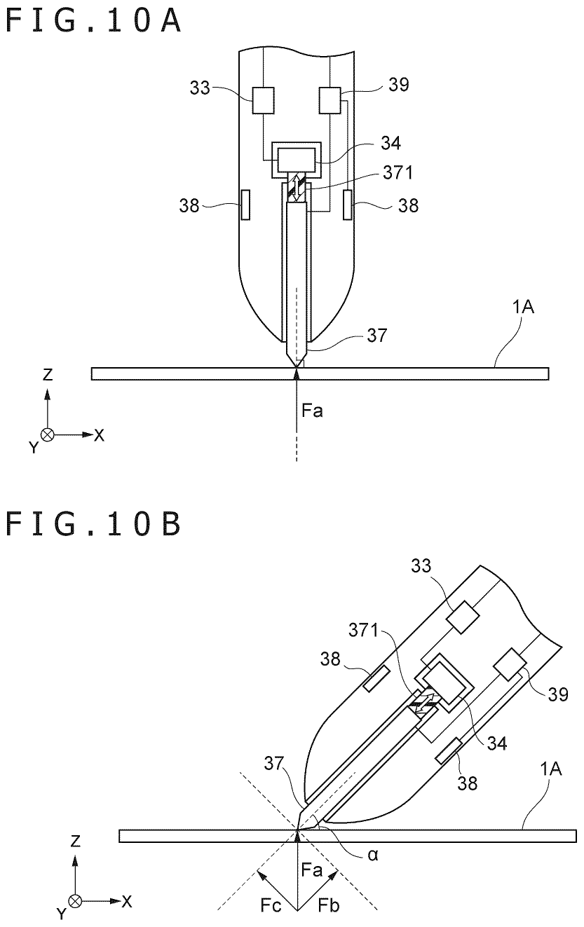

FIG. 10A is a sectional view of a position detection system 5 according to the third embodiment, the sectional view being taken along a line X-X. In addition, FIG. 10B is a sectional view in a case where the electronic pen 3 is inclined with respect to the electronic apparatus 1A in the position detection system 5 illustrated in FIG. 10A. Incidentally, suppose that, in FIG. 10A and FIG. 10B, a pressure Fa is applied to the pen tip of the electronic pen 3 in a normal direction of going upward from the display panel 40 of the electronic apparatus 1A. In addition, in a case where a vector of the pressure Fa is decomposed in an axial direction of the electronic pen 3 and a direction perpendicular to the axial direction in FIG. 10B, a component thereof in the axial direction of the electronic pen 3 is set as a pressure Fb, and a component thereof in the direction perpendicular to the axial direction is set as a pressure Fc. As illustrated in FIG. 10B, it is understood that, the larger an inclination a of the electronic pen 3 with respect to the display surface of the electronic apparatus 1A, the lower the pressure Fb applied in the axial direction of the pen tip of the electronic pen 3.

In addition, as illustrated in FIG. 10A, the electronic pen 3 is provided such that the pen tip thereof can reciprocate along the axial direction of the electronic pen 3. In addition, the electronic pen 3 is provided with an air gap between the pen tip and the sensor 34, and the air gap is provided with a buffer 371 that transmits the pressure applied to the pen tip to the sensor 34. In addition, the pen tip is provided with the electrode 37 at a distal end thereof, or the pen tip itself functions as the electrode 37. The sensor 34 includes a capacitor switch that changes in capacitance according to the pressure. The sensor 34 detects the pressure applied thereto from the pen tip via the buffer 371, by changing the capacitance thereof according to the pressure, and transmits the detected pressure as the pen pressure signal to the pen controller 36 via the data manager 33.

The pen controller 36 calculates the pen pressure value regarding the pen pressure on the basis of a change in the potential of an uplink signal transmitted thereto from the pen sensor 10 via the electrode 37. Specifically, when the potential of the uplink signal has risen by the first potential or more within the predetermined time, the pen controller 36 determines that the operation state has made a transition to the first state, and calculates the pen pressure value as the first value. In addition, when the potential of the uplink signal has fallen by the second potential or more within the predetermined time, the pen controller 36 determines that the operation state has made a transition to the second state, and calculates the pen pressure value as the second value. Incidentally, the pen controller 36 may calculate the pen pressure value by correcting the pressure detected by the sensor 34 on the basis of a change in the potential of the uplink signal.

Incidentally, further details of the operation of the pen controller 36 are similar to those of the first embodiment or the second embodiment except that the pen pressure value is calculated or corrected on the basis of a change in the potential of the uplink signal in place of the position signal. A description thereof will therefore be omitted.

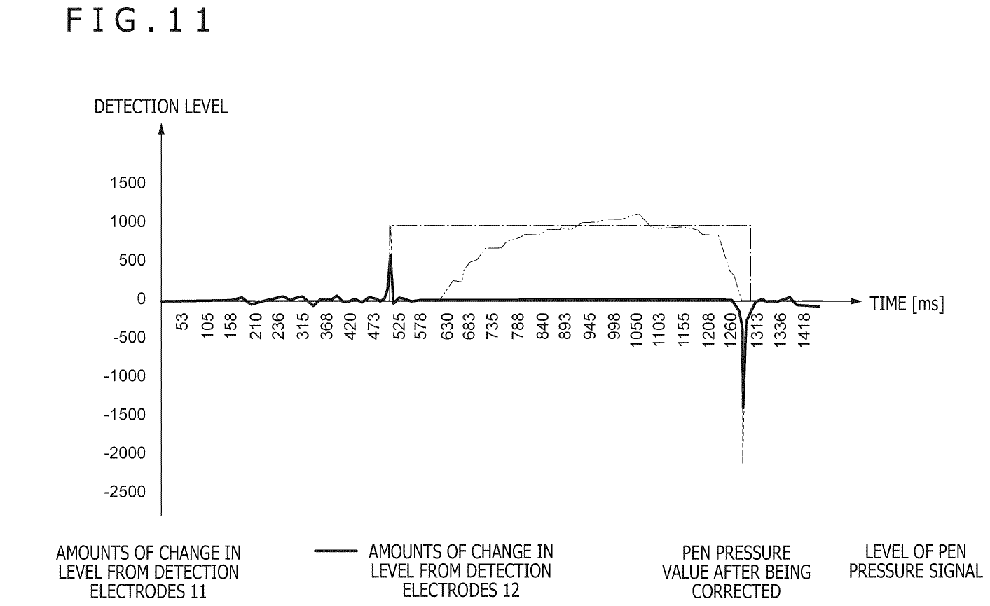

An example of the calculation of the pen pressure by the pen controller 36 will be described with reference to FIG. 11. FIG. 11 is a graph illustrating an example of relation between amounts of change in the level of the uplink signal and the pen pressure value in a case where the inclination a of the electronic pen 3 is large in the third embodiment. In FIG. 11, an axis of ordinates indicates detection levels obtained by conversion of the potentials into a common scale by a predetermined conversion equation. In addition, in FIG. 11, an axis of abscissas indicates elapsed time [ms]. The graph illustrated in FIG. 11 illustrates data indicating a difference in the level of the uplink signal transmitted from the detection electrodes 11 from a previous one, data indicating a difference in the level of the uplink signal transmitted from the detection electrodes 12 from a previous one, and data indicating the levels of the pen pressure value and the pen pressure signal. In addition, suppose that, in FIG. 11, detection levels associated with the first potential and the second potential are each 200, the predetermined time is 10 ms, the first value is 1000, and the second value is 0.

As illustrated in FIG. 11, the pen controller 36 calculates the pen pressure value as the first value considerably earlier than the uplink signal indicates a pressing of the pen sensor 10 by the electronic pen 3. The pen controller 36 then transmits the pen pressure value to the host processor 30. In addition, the pen controller 36 calculates the pen pressure value as the second value immediately after the pen pressure signal indicates that the electronic pen 3 is separated from the pen sensor 10.

It is to be noted that, while, in the third embodiment, the electronic pen 3 is provided with the sensor 34 for detecting the pen pressure and transmits the pen pressure signal, the electronic pen 3 is not limited to this. The electronic pen 3 may not include the sensor 34. Further, the electronic pen 3 may calculate the pen pressure value regarding the pen pressure simply on the basis of the signal level of the uplink signal.

### Effects

As described above, in the third embodiment, the electronic pen 3 is an electronic pen 3 that indicates a position on the pen sensor 10. The electronic pen 3 includes the pen tip that is provided to the distal end thereof in a manner where the pen tip is capable of reciprocating along the axial direction and has the electrode 37 that transmits and receives signals to and from the pen sensor 10, the pen controller 36, and the transmitting unit TX. The pen controller 36 calculates the pen pressure value regarding the pen pressure on the basis of a change in the potential of the uplink signal transmitted thereto from the pen sensor 10 via the electrode 37. The transmitting unit TX transmits the pen pressure signal indicating the pen pressure value calculated by the pen controller 36 and the position signal indicating the indicated position on the pen sensor 10 to the pen sensor 10 via the electrode 37.

According to this configuration, the electronic pen 3 calculates the pen pressure value on the basis of a change in the signal level of the uplink signal, and therefore reduces an effect of variation in the signal level of the position signal due to manufacturing variation in the electronic pen 3 or the like. In addition, the electronic pen 3 uses the uplink signal in calculating the pen pressure value, and therefore reduces an effect produced on the sensor 34 by a degree of inclination of the electronic pen 3 with respect to the pen sensor 10. Hence, the electronic pen 3 can calculate the pen pressure of the electronic pen 3 on the pen sensor 10 with high accuracy.

In addition, in the third embodiment, when the potential of the uplink signal has risen by the first potential or more within the predetermined time, the pen controller 36 determines that the operation state has made a transition to the first state in which the electronic pen 3 is pressing the pen sensor 10, and the pen controller 36 calculates the pen pressure value as the first value. Here, the signal level is a potential.

Hence, because the electronic pen 3 calculates the pen pressure value according to an amount of rise in the potential of the uplink signal, the electronic pen 3 can determine a pressing of the electronic pen 3 against the pen sensor 10 with a simple configuration and with high accuracy, and calculate the pen pressure value according to the pressing.

In addition, in the third embodiment, when the potential of the uplink signal has fallen by the second potential or more within the predetermined time, the pen controller 36 determines that the operation state has made a transition to the second state in which the electronic pen 3 is separated from the pen sensor 10, and the pen controller 36 calculates the pen pressure value as the second value different from the first value.

Hence, because the electronic pen 3 calculates the pen pressure value according to an amount of fall in the potential of the uplink signal, the electronic pen 3 can determine a separation of the electronic pen 3 from the pen sensor 10 with a simple configuration and with high accuracy, and calculate the pen pressure value according to the separation.

In addition, in the third embodiment, the electronic pen 3 further includes the sensor 34 (pressure sensor) that detects the pressure applied to the pen tip. In addition, the pen controller 36 calculates the pen pressure value by correcting the pressure detected by the sensor 34, on the basis of a change in the signal level of the uplink signal. Here, the signal level is a potential.

Hence, because the electronic pen 3 corrects the pressure detected by the sensor 34, the electronic pen 3 can calculate the pen pressure of the electronic pen 3 on the pen sensor 10 with high accuracy.

In addition, in the third embodiment, when the potential of the uplink signal has risen by the first potential or more within the predetermined time, the pen controller 36 determines that the operation state has made a transition to the first state, and calculates the pen pressure value as the first value. Meanwhile, when the pen pressure signal indicates that the electronic pen 3 is pressing the pen sensor 10 before the pen controller 36 determines that the operation state has made a transition to the first state, the pen controller 36 determines that the pen pressure signal is indicating an abnormal value, and calculates the pen pressure value as the second value. Here, the signal level is a potential.

Hence, the electronic pen 3 can determine an erroneous detection of the pressing by the sensor 34 as an abnormality, and can therefore calculate the pen pressure of the electronic pen 3 on the pen sensor 100 with higher accuracy.

In addition, in the third embodiment, when the potential of the uplink signal has fallen by the second potential or more within the predetermined time, the pen controller 36 determines that the operation state has made a transition to the second state, and calculates the pen pressure value as the second value. Meanwhile, when the pen pressure signal indicates that the electronic pen 3 is separated from the pen sensor 10 before the pen controller 36 determines that the operation state has made a transition to the second state, the pen controller 36 determines that the pen pressure signal is indicating an abnormal value, and the pen controller 36 maintains the pen pressure value.

Hence, the electronic pen 3 can determine an erroneous detection of the separation of the electronic pen 3 by the pen pressure sensor as an abnormality, and can therefore calculate the pen pressure of the electronic pen 3 on the pen sensor 10 with higher accuracy.

### Fourth Embodiment

A fourth embodiment will next be described.

The fourth embodiment is different from the first embodiment in that the sensor controller 20 of the electronic apparatus 1A in the fourth embodiment calculates the pen pressure value of the electronic pen 3 on the basis of a first signal transmitted from the electrode 37 of the electronic pen 3 and a second signal transmitted from the electrode 38 of the electronic pen 3. In addition, suppose that the electronic pen 3 in the fourth embodiment includes the sensor 34 (pressure sensor) described in the third embodiment.

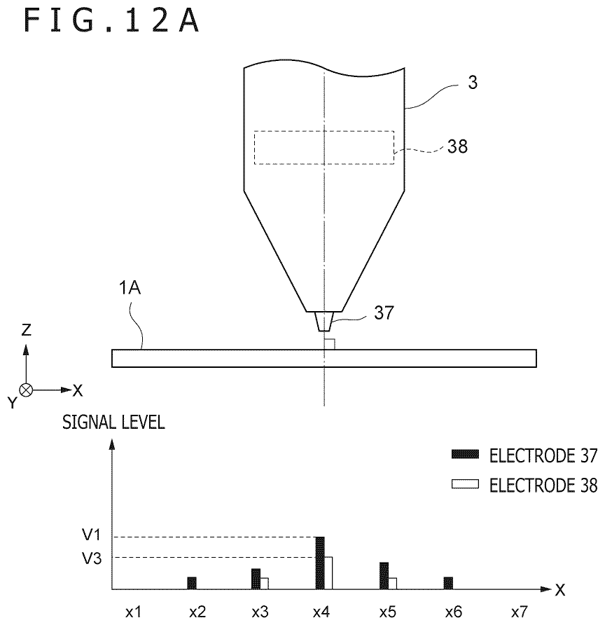

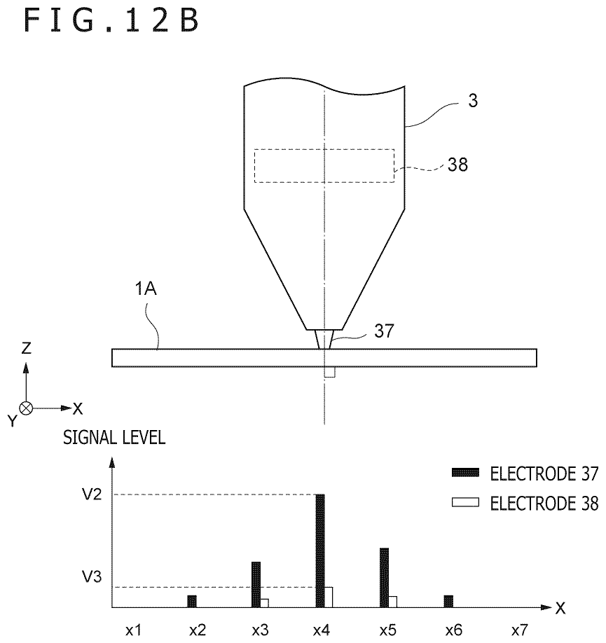

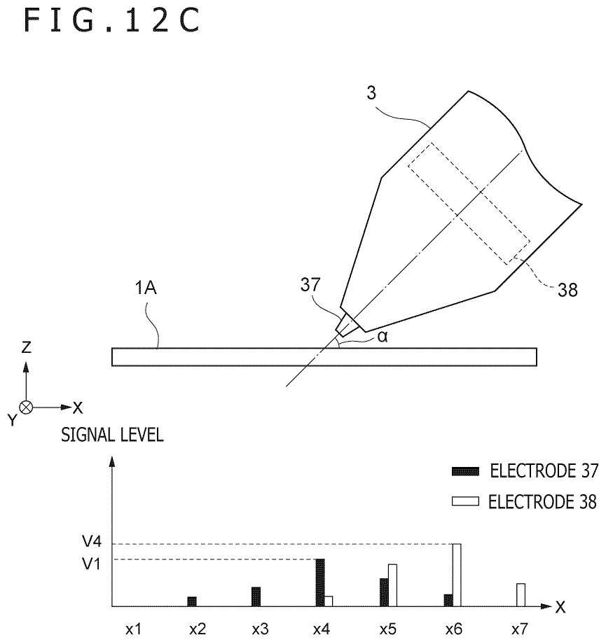

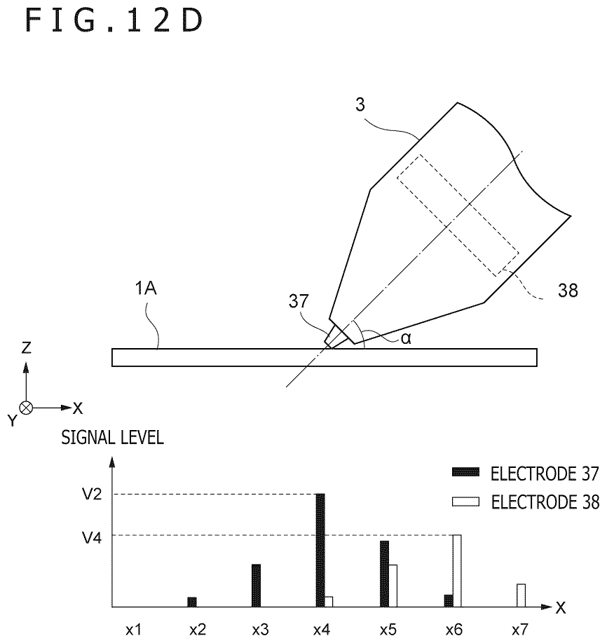

FIG. 12A is a diagram illustrating an example of a signal level distribution in a case where the electronic pen 3 is not in contact with the electronic apparatus 1A and has a small inclination with respect to the electronic apparatus 1A in the fourth embodiment. Incidentally, in FIG. 12A and FIGS. 12B to 12D to be described later, axes of ordinates in the graphs indicate the signal levels (potentials or the like) of the first signal and the second signal. In addition, axes of abscissas in the graphs indicate coordinate values in the X-axis direction on the pen sensor 10. In addition, suppose that, in FIG. 12A and FIG. 12B, the inclination of the electronic pen 3 with respect to the pen sensor 10 (that is, an angle between a normal to the detecting surface of the pen sensor 10 and the axial direction of the electronic pen 3) is 0°. In the fourth embodiment, the electronic pen 3 transmits, to the pen sensor 10, the first signal including information regarding an indicated position such as an indication of a coordinate value by the electronic pen 3 on the pen sensor 10. In addition, the first signal may include information regarding the pressure detected by the sensor 34, that is, the pen pressure of the electronic pen 3 on the pen sensor 10. In addition, the electronic pen 3 transmits, to the pen sensor 10, the second signal including a posture value regarding the posture of the electronic pen 3 on the pen sensor 10.

As illustrated in FIG. 12A, the pen sensor 10 receives the first signal transmitted from the electrode 37. The first signal has a highest signal level, that is, a value V1, at a coordinate x4 among coordinate values (x1 to x7) in the X-axis direction on the pen sensor 10. In addition, the second signal has a highest signal level, that is, a value V3, at the coordinate x4 among the coordinate values (x1 to x7) in the X-axis direction on the pen sensor 10. Incidentally, the level of the second signal is a smaller value as a whole than the level of the first signal because a distance between the pen sensor 10 and the electrode 38 is longer than a distance between the pen sensor 10 and the electrode 37. In addition, in FIG. 12A, the coordinate value at which the signal level of the first signal becomes a maximum value and the coordinate value at which the signal level of the second signal becomes a maximum value coincide with each other because of the small inclination of the electronic pen 3 with respect to the pen sensor 10.

FIG. 12B is a diagram illustrating an example of a signal level distribution in a case where the electronic pen 3 is in contact with the electronic apparatus 1A and has a small inclination with respect to the electronic apparatus 1A in the fourth embodiment. In FIG. 12B, the first signal has a highest signal level, that is, a value V2 larger than the value V1, at the coordinate x4 among the coordinate values (x1 to x7) in the X-axis direction on the pen sensor 10. It is understood that, because the electronic pen 3 is in contact with the pen sensor 10, the first signal is increased in signal level as compared with the noncontact case. In addition, the second signal has a highest signal level, that is, the value V3, at the coordinate x4 among the coordinate values (x1 to x7) in the X-axis direction on the pen sensor 10. Incidentally, the level of the second signal is actually a signal level slightly larger than the value V3 because the distance between the electrode 38 and the pen sensor 10 becomes short as compared with the case where the electronic pen 3 is not in contact with the pen sensor 10. However, this represents a change in a negligible range. The level of the second signal is therefore assumed to be the value V3 for convenience. In FIG. 12B, as in FIG. 12A, the coordinate value at which the signal level of the first signal becomes a maximum value and the coordinate value at which the signal level of the second signal becomes a maximum value coincide with each other because of the small inclination of the electronic pen 3 with respect to the pen sensor 10.

FIG. 12C is a diagram illustrating an example of a signal level distribution in a case where the electronic pen 3 is not in contact with the electronic apparatus 1A and has a large inclination with respect to the electronic apparatus 1A in the fourth embodiment. Suppose that, in FIG. 12C, the inclination of the electronic pen 3 with respect to the pen sensor 10 (that is, the angle between the normal to the detecting surface of the pen sensor 10 and the axial direction of the electronic pen 3) is 90°−α. In addition, in FIG. 12C, the first signal has a highest signal level, that is, the value V1, at the coordinate x4 among the coordinate values (x1 to x7) in the X-axis direction on the pen sensor 10. In addition, the second signal has a highest signal level, that is, a value V4 larger than the value V3, at the coordinate x6 among the coordinate values (x1 to x7) in the X-axis direction on the pen sensor 10. It is understood that, because the electronic pen 3 has a large inclination with respect to the pen sensor 10, and the distance between the electrode 38 and the pen sensor 10 is short as compared with the case where the inclination is small, the second signal is increased in signal level as compared with the noncontact case. In FIG. 12C, the coordinate value at which the signal level of the first signal becomes a maximum value and the coordinate value at which the signal level of the second signal becomes a maximum value do not coincide with each other because of the large inclination of the electronic pen 3 with respect to the pen sensor 10.

FIG. 12D is a diagram illustrating an example of a signal level distribution in a case where the electronic pen 3 is in contact with the electronic apparatus 1A and has a large inclination with respect to the electronic apparatus 1A in the fourth embodiment. Suppose that, in FIG. 12D, the inclination of the electronic pen 3 with respect to the pen sensor 10 (that is, the angle between the normal to the detecting surface of the pen sensor 10 and the axial direction of the electronic pen 3) is 90°−α. In FIG. 12D, the first signal has a highest signal level, that is, the value V2, at the coordinate x4 among the coordinate values (x1 to x7) in the X-axis direction on the pen sensor 10. In addition, the second signal has a highest signal level, that is, the value V4, at the coordinate x6 among the coordinate values (x1 to x7) in the X-axis direction on the pen sensor 10. It is understood that, because the electronic pen 3 is in contact with the pen sensor 10, the first signal is increased in signal level as compared with the noncontact case. In addition, it is understood that, because the electronic pen 3 has a large inclination with respect to the pen sensor 10, and the distance between the electrode 38 and the pen sensor 10 is short as compared with the case where the inclination is small, the second signal is increased in signal level as compared with the case where the inclination is small. In FIG. 12D, the coordinate value at which the signal level of the first signal becomes a maximum value and the coordinate value at which the signal level of the second signal becomes a maximum value do not coincide with each other because of the large inclination of the electronic pen 3 with respect to the pen sensor 10. Incidentally, while the coordinate values in the X-axis direction are cited as an example in FIGS. 12A to 12D, coordinate values in the Y-axis direction will also be handled in a similar manner to the coordinate values in the X-axis direction.

A method of calculating the pen pressure in the fourth embodiment will next be described. The obtaining section 22 in the fourth embodiment obtains, from the pen sensor 10, the first signal transmitted from the electrode 37 (first electrode) of the electronic pen 3 to the pen sensor 10. In addition, the obtaining section 22 obtains, from the pen sensor 10, the second signal transmitted from the electrode 38 (second electrode) different from the electrode 37 in the electronic pen 3 to the pen sensor 10. In addition, the obtaining section 22 obtains the pen pressure signal indicating the pen pressure of the electronic pen 3 from the pen sensor 10. Incidentally, suppose that the pen pressure signal is transmitted from the electrode 37 of the electronic pen 3. In addition, the obtaining section 22 stores, in the storage section 21, information indicated by the first signal, the second signal, and the pen pressure signal that are obtained.

In addition, in the fourth embodiment, the storage section 21 stores a correction table for correcting or calculating the pen pressure according to the inclination angle of the electronic pen 3 with respect to the pen sensor 10 (that is, the angle between the normal to the detecting surface of the pen sensor 10 and the axial direction of the electronic pen 3). The correction table, for example, associates a calculated value calculated from signal distributions of the first signal and the second signal with a correction coefficient. The correction coefficient is basically such a value (for example, a value larger than 1) as to increase the pen pressure value indicated by the pen pressure signal. However, the correction coefficient is not limited to this, but may be such a value (for example, a value smaller than 1) as to decrease the pen pressure value indicated by the pen pressure signal. In addition, the storage section 21 may store, in place of the correction table, a predetermined arithmetic expression or function in which a value regarding the signal distribution of the first signal and a value regarding the signal distribution of the second signal are input variables and the correction coefficient is an output variable.

The correction table associates the calculated value and the correction coefficient with each other such that, the smaller the calculated value, the larger the value of the correction coefficient. This indicates that, as the electronic pen 3 is inclined with respect to the pen sensor 10, the electrode 38 approaches the pen sensor 10, and therefore, the signal level of the second signal with respect to the signal level of the first signal is increased. In addition, the correction table may associate, with the correction coefficient, a difference between a coordinate value on the pen sensor 10 at which a statistical value (preferably a maximum value) of the signal level of the first signal is detected and a coordinate value at which a statistical value (preferably a maximum value) of the signal level of the second signal is detected. The present example is an example in which the inclination of the electronic pen 3 with respect to the pen sensor 10 is set as the calculated value according to the difference between the coordinate values at which the maximum values are detected. The more the electronic pen 3 is inclined with respect to the pen sensor 10, the larger the difference between the coordinate value at which the maximum value of the signal level of the first signal is indicated and the coordinate value at which the maximum value of the signal level of the second signal is indicated. In addition, the correction table may associate, with the correction coefficient, a difference between a vector of acceleration detected by an acceleration sensor mounted in the electronic pen 3 in advance and a vector of acceleration detected by an acceleration sensor mounted in the electronic apparatus 1A in advance. The present example is an example in which a difference between the acceleration applied to the electronic pen 3 and the acceleration applied to the electronic apparatus 1A is set as the calculated value indicating the inclination of the electronic pen 3 with respect to the pen sensor 10.

The pen pressure calculating section 23 calculates the pen pressure value regarding the pen pressure of the electronic pen 3 on the pen sensor 10 on the basis of a change in the potential of the first signal, a change in the potential of the second signal, and the pen pressure signal, where signals are obtained by the obtaining section 22. Specifically, when a potential difference between the first signal and the second signal has risen by the first potential or more within the predetermined time, the pen pressure calculating section 23 determines that the operation state has made a transition to the first state. In addition, when the potential difference between the first signal and the second signal has fallen by the second potential or more within the predetermined time, the pen pressure calculating section 23 determines that the operation state has made a transition to the second state. Incidentally, in calculating the potential difference between the first signal and the second signal, the pen pressure calculating section 23 uses a statistical value of the signal distribution of the first signal and a statistical value of the signal distribution of the second signal. Incidentally, the statistical values of the signal distributions are, for example, maximum values, median values, average values, or the like of the signal levels. Then, the pen pressure calculating section 23 calculates the pen pressure value according to the signal distributions of the first signal and the second signal and the pen pressure signal. In addition, when the potentials of the first signal and the second signal do not meet the above-described conditions, the pen pressure calculating section 23 determines that the operation state has not changed, and the pen pressure calculating section 23 maintains the pen pressure value. The pen pressure calculating section 23 stores the determined present operation state in the operation state data 213 in the storage section 21.

The pen pressure calculating section 23 calculates the pen pressure value such that, in the first state and the second state, the larger the inclination angle of the electronic pen 3 with respect to the pen sensor 10, the larger the pen pressure value, and the smaller the inclination angle, the smaller the pen pressure value. Specifically, the pen pressure calculating section 23 calculates, as the calculated value, a value obtained by subtracting the maximum value of the signal level of the second signal from the maximum value of the signal level of the first signal. The pen pressure calculating section 23 refers to the correction table stored in the storage section 21 and obtains the correction coefficient associated with the calculated value. Then, the pen pressure calculating section 23 corrects the pen pressure value by multiplying the pen pressure value indicated by the pen pressure signal by the obtained correction coefficient. Incidentally, when the pen pressure signal indicates that the electronic pen 3 is not pressing the pen sensor 10 in the first state, the pen pressure calculating section 23 may calculate the pen pressure value as the first value indicating that the electronic pen 3 is pressing the pen sensor 10.

Incidentally, in determining the operation state, the pen pressure calculating section 23 may use the potential of the first signal or the second signal rather than the potential difference between the first signal and the second signal. Specifically, when the potential of the first signal or the second signal has risen by the first potential or more within the predetermined time in the second state, the pen pressure calculating section 23 may determine that the operation state has made a transition to the first state. In addition, when the potential of the first signal or the second signal has fallen by the second potential or more within the predetermined time in the first state, the pen pressure calculating section 23 may determine that the operation state has made a transition to the second state. In addition, in determining the operation state, the pen pressure calculating section 23 may use a ratio between the potentials rather than the potential difference between the first signal and the second signal. In addition, in determining the operation state, the pen pressure calculating section 23 may use an area of the signal distribution of the first signal or an area of the signal distribution of the second signal. In addition, in determining the operation state, the pen pressure calculating section 23 may use an area ratio of the signal distribution of the second signal to the signal distribution of the first signal. In addition, in determining the operation state, the pen pressure calculating section 23 may use an overlap area between the signal distribution of the first signal and the signal distribution of the second signal.

In addition, the pen pressure calculating section 23 may calculate the inclination angle of the electronic pen 3 with respect to the pen sensor 10 in place of the calculated value. Further, the correction table may associate the inclination angle and the correction coefficient with each other. The inclination angle is, for example, calculated from the coordinate value at which the maximum value of the signal level of the first signal is detected and the coordinate value at which the maximum value of the signal level of the second signal is detected as well as a distance between the electrodes 37 and 38 which distance is stored in advance. However, the inclination angle is not limited to this.

### Flow of Series of Operations

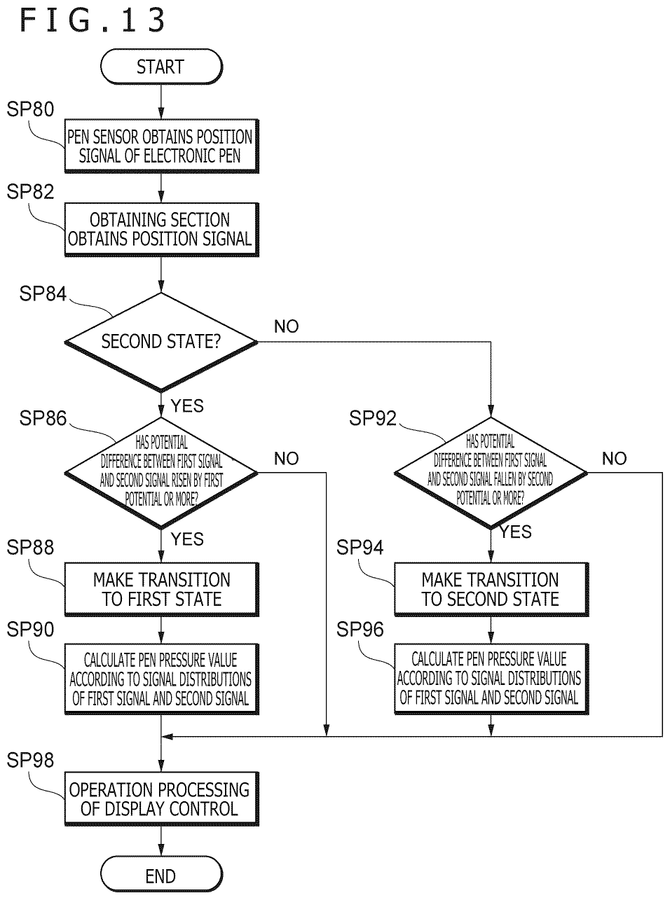

The functional configurations of the sensor controller 20 according to the fourth embodiment have been described above. A flow of specific processing in the electronic apparatus 1A according to the fourth embodiment will next be described in detail. FIG. 13 is a flowchart illustrating an example of a flow of a series of processing by the electronic apparatus 1A according to the fourth embodiment. Incidentally, the contents and order of processing of the following steps can be changed as appropriate.

### (Step SP80)

Via the pen sensor 10, the electronic apparatus 1A obtains the first signal and the second signal transmitted from the electronic pen 3 to the pen sensor 10. The first signal is a signal transmitted from the electrode 37 of the electronic pen 3 and is a signal indicating a position indicated by the electronic pen 3 on the pen sensor 10. The first signal may include the pen pressure value regarding the pen pressure of the electronic pen 3 applied from the electronic pen 3 to the pen sensor 10. The second signal is a signal transmitted from the electrode 38 of the electronic pen 3 and is a signal indicating the inclination of the electronic pen 3 on the pen sensor 10. The processing then proceeds to the processing of step SP82.

### (Step SP82)

Via the obtaining section 22, the electronic apparatus 1A obtains the position signal transmitted from the detection electrodes 11 and 12 of the pen sensor 10. The processing then proceeds to the processing of step SP84.

### (Step SP84)

Via the pen pressure calculating section 23, the electronic apparatus 1A refers to the operation state data 213 in the storage section 21 and determines whether or not the present operation state is the second state. Then, when the determination is a positive determination, the processing proceeds to the processing of step SP86. When the determination is a negative determination, on the other hand, the electronic apparatus 1A determines that the present operation state is the first state, and the processing proceeds to the processing of step SP92.

### (Step SP86)

Via the pen pressure calculating section 23, the electronic apparatus 1A determines whether or not the potential difference between the first signal and the second signal has risen by the first potential or more during the predetermined time. Incidentally, via the pen pressure calculating section 23, the electronic apparatus 1A may determine whether or not the potential difference between the first signal and the second signal has risen by the first potential or more from a previously obtained potential difference. Then, when the determination is a positive determination, the processing proceeds to the processing of step SP88. When the determination is a negative determination, on the other hand, the processing proceeds to the processing of step SP98.

### (Step SP88)

Via the pen pressure calculating section 23, the electronic apparatus 1A determines that the operation state has made a transition from the second state to the first state. Via the pen pressure calculating section 23, the electronic apparatus 1A updates the operation state data 213 in the storage section 21 in such a manner as to indicate that the present operation state is the first state. The processing then proceeds to the processing of step SP90.

### (Step SP90)

Via the pen pressure calculating section 23, the electronic apparatus 1A calculates the pen pressure value according to the signal distributions of the first signal and the second signal. In addition, via the pen pressure calculating section 23, the electronic apparatus 1A transmits the calculated pen pressure value to the host processor 30. The processing then proceeds to the processing of step SP98.

### (Step SP92)

Via the pen pressure calculating section 23, the electronic apparatus 1A determines whether or not the potential difference between the first signal and the second signal has fallen by the second potential or more during the predetermined time. Incidentally, via the pen pressure calculating section 23, the electronic apparatus 1A may determine whether or not the potential difference between the first signal and the second signal has fallen by the second potential or more from a previously obtained potential difference. Then, when the determination is a positive determination, the processing proceeds to the processing of step SP94. When the determination is a negative determination, on the other hand, the processing proceeds to the processing of step SP98.

### (Step SP94)

Via the pen pressure calculating section 23, the electronic apparatus 1A determines that the operation state has made a transition from the first state to the second state. Via the pen pressure calculating section 23, the electronic apparatus 1A updates the operation state data 213 in the storage section 21 in such a manner as to indicate that the present operation state is the second state. The processing then proceeds to the processing of step SP96.

### (Step SP96)

Via the pen pressure calculating section 23, the electronic apparatus 1A calculates the pen pressure value according to the signal distributions of the first signal and the second signal. In addition, via the pen pressure calculating section 23, the electronic apparatus 1A transmits the calculated pen pressure value to the host processor 30. The processing then proceeds to the processing of step SP98.

### (Step SP98)

Via the host processor 30, the electronic apparatus 1A performs an operation of display control on the display panel 40 according to the pen pressure indicated by the pen pressure value transmitted from the pen pressure calculating section 23. The series of processing illustrated in FIG. 13 is then ended.

As described above, in the fourth embodiment, the sensor controller 20 includes the obtaining section 22 and the pen pressure calculating section 23. In addition, the obtaining section 22 obtains, from the pen sensor 10 that detects the position of the electronic pen 3, the first signal transmitted from the electrode 37 (first electrode) of the electronic pen 3 to the pen sensor 10. The obtaining section 22 also obtains the second signal transmitted from the electrode 38 (second electrode) different from the electrode 37 in the electronic pen 3 to the pen sensor 10. The obtaining section 22 also obtains the pen pressure signal indicating the pen pressure of the electronic pen 3. The pen pressure calculating section 23 then calculates the pen pressure value regarding the pen pressure of the electronic pen 3 on the pen sensor 10 on the basis of changes in the signal levels of the first signal and the second signal as well as the pen pressure signal.

According to this configuration, the sensor controller 20 uses the first signal transmitted from the electrode 37 and the second signal transmitted from the electrode 38 in calculating the pen pressure value. Hence, the sensor controller 20 can calculate the value of the pen pressure of the electronic pen 3 on the pen sensor 10 with high accuracy even when the electronic pen 3 has a large inclination with respect to the pen sensor 10, which would typically result in a decrease in accuracy of pen pressure detection by the electronic pen 3. Notably, unlike a conventional configuration described in U.S. Pat. No. 10,345,928, the sensor controller 20 does not necessarily need to calculate the angle of the electronic pen 3 with respect to the pen sensor 10. Hence, the sensor controller 20 can calculate the pen pressure value regarding the pen pressure of the electronic pen 3 on the pen sensor 10 without calculating the angle of the electronic pen 3 with respect to the pen sensor 10.

In addition, the pen pressure calculating section 23 calculates the pen pressure value such that, the larger the inclination angle of the electronic pen 3 with respect to the detecting surface of the pen sensor 10, the larger the pen pressure value, and the smaller the inclination angle, the smaller the pen pressure value.

According to this configuration, the sensor controller 20 applies a correction to the pen pressure value for a case where, the larger the inclination angle of the electronic pen 3 with respect to the pen sensor 10, the smaller the pen pressure detected by the electronic pen 3. Hence, the sensor controller 20 can calculate the value of the pen pressure of the electronic pen 3 on the pen sensor 10 with high accuracy even when the electronic pen 3 is inclined with respect to the pen sensor 10.

In addition, when the potential of the first signal or the second signal has risen by the first potential or more within the predetermined time, the pen pressure calculating section 23 determines that the operation state has made a transition to the first state in which the electronic pen 3 is pressing the pen sensor 10, and the pen pressure calculating section 23 calculates the pen pressure value as the first value. Here, the signal level is a potential.

Hence, the sensor controller 20 can calculate the value of the pen pressure on the pen sensor 10 with high accuracy even when the accuracy of detection of the pen pressure by the electronic pen 3 is decreased.

In addition, when the potential difference between the first signal and the second signal has risen by the first potential or more within the predetermined time, the pen pressure calculating section 23 determines that the operation state has made a transition to the first state in which the electronic pen 3 is pressing the pen sensor 10, and the pen pressure calculating section 23 calculates the pen pressure value as the first value. Here, the signal level is a potential.

Hence, the sensor controller 20 can calculate the value of the pen pressure on the pen sensor 10 with high accuracy even when the accuracy of detection of the pen pressure by the electronic pen 3 is decreased.

### Fifth Embodiment

A fifth embodiment will next be described.

In the fifth embodiment, the sensor controller 20 determines a reference for determining whether or not the operation state has made a transition according to a movement speed of the electronic pen 3. In the fifth embodiment, the storage section 21 stores a speed threshold value regarding the movement speed of the electronic pen 3 with respect to the pen sensor 10. In addition, the storage section 21 stores a third potential and a fourth potential regarding the first potential. The third potential is a value of a potential determined as the first potential when the movement speed of the electronic pen 3 is equal to or higher than the speed threshold value. In addition, the fourth potential is a value of a potential determined as the first potential when the movement speed of the electronic pen 3 is lower than the speed threshold value. The fourth potential is a value higher than the third potential. Further, the storage section 21 stores a fifth potential and a sixth potential regarding the second potential. The fifth potential is a value of a potential determined as the second potential when the movement speed of the electronic pen 3 is equal to or higher than the speed threshold value. In addition, the sixth potential is a value of a potential determined as the second potential when the movement speed of the electronic pen 3 is lower than the speed threshold value. The sixth potential is a value higher than the fifth potential. In other words, the third potential and the fifth potential are respective values of the first potential and the second potential in a case where a determination criterion is relaxed in determining whether or not the operation state has made a transition. In addition, the fourth potential and the sixth potential are respective values of the first potential and the second potential as usual in a case where the relaxation of the determination criterion is not performed in determining whether or not the operation state has made a transition.

### Flow of Series of Operations

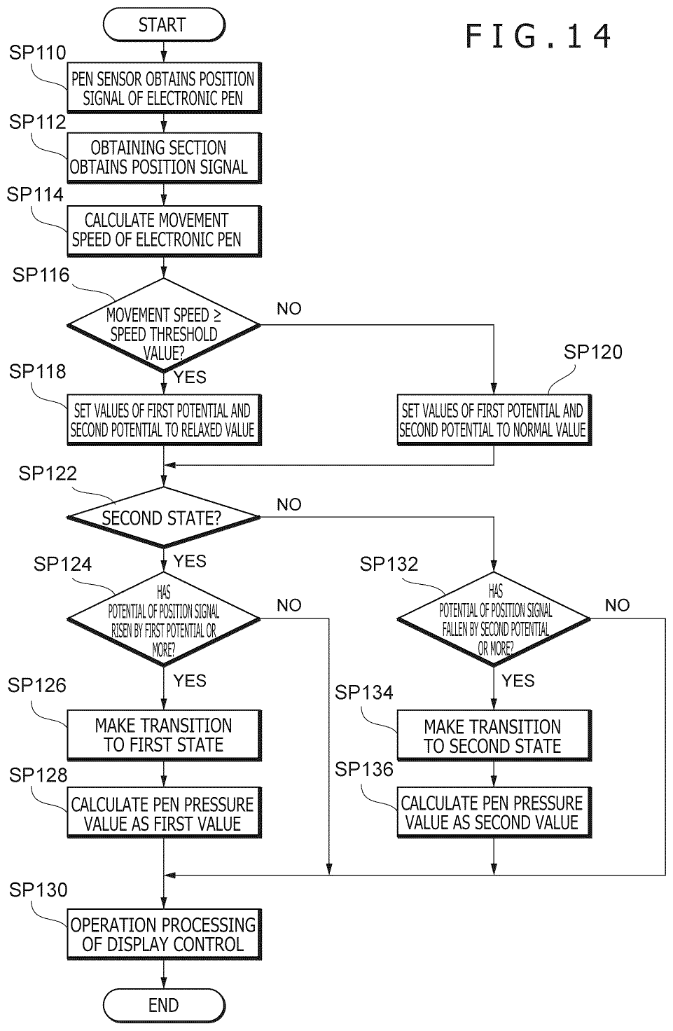

Here, a flow of specific processing of the electronic apparatus 1A in the fifth embodiment will be described with reference to FIG. 14. FIG. 14 is a flowchart illustrating an example of a flow of a series of processing by the electronic apparatus 1A according to the fifth embodiment. Incidentally, in FIG. 14, the processing of step SP110 and step SP112 is the same as the processing of step SP10 and step SP12 in the first embodiment, and therefore, a description thereof will be omitted here. In addition, in FIG. 14, the processing of steps SP122 to SP136 is the same as the processing of steps SP14 to SP28 in the first embodiment, and therefore, a description thereof will be omitted here.

### (Step SP114)

Via the pen pressure calculating section 23, the electronic apparatus 1A calculates the movement speed of the electronic pen 3 with respect to the pen sensor 10 from the position signal obtained by the obtaining section 22. Specifically, via the pen pressure calculating section 23, the electronic apparatus 1A extracts a coordinate value indicating the position of the electronic pen 3 on the pen sensor 10 from the position signal obtained by the obtaining section 22. Via the pen pressure calculating section 23, the electronic apparatus 1A stores the extracted coordinate value in the storage section 21. The coordinate value includes a coordinate value in the X-axis direction and a coordinate value in the Y-axis direction on the pen sensor 10. Via the pen pressure calculating section 23, the electronic apparatus 1A calculates a difference between the present extracted coordinate value and a previously extracted coordinate value. Via the pen pressure calculating section 23, the electronic apparatus 1A sets, as the movement speed, a division result obtained by dividing the calculated difference by a time elapsed from the extraction of the previous coordinate value to the extraction of the present coordinate value. The processing then proceeds to the processing of step SP116.

### (Step SP116)

Via the pen pressure calculating section 23, the electronic apparatus 1A determines whether or not the calculated movement speed is equal to or higher than the speed threshold value. Then, when the determination is a positive determination, the processing proceeds to the processing of step SP118. When the determination is a negative determination, on the other hand, the processing proceeds to the processing of step SP120.

### (Step SP118)

Via the pen pressure calculating section 23, the electronic apparatus 1A sets the value of the first potential to the value of the third potential (relaxed value). In addition, via the pen pressure calculating section 23, the electronic apparatus 1A sets the value of the second potential to the value of the fifth potential (relaxed value). That is, the pen pressure calculating section 23 relaxes the reference (the first potential and the second potential) for determining whether or not the operation state has made a transition. The processing then proceeds to the processing of step SP122.

### (Step SP120)

Via the pen pressure calculating section 23, the electronic apparatus 1A sets the value of the first potential to the value of the fourth potential (value as usual). Via the pen pressure calculating section 23, the electronic apparatus 1A sets the value of the second potential to the value of the sixth potential (value as usual). That is, the pen pressure calculating section 23 makes the reference (the first potential and the second potential) for determining whether or not the operation state has made a transition remain as usual without relaxing the reference. The processing then proceeds to the processing of step SP122.

### Effects

As described above, in the fifth embodiment, the pen pressure calculating section 23 calculates the movement speed of the electronic pen 3 with respect to the pen sensor 10 from the position signal. In addition, the pen pressure calculating section 23 determines the value of the first potential according to the calculated movement speed.

According to this configuration, the sensor controller 20 determines the value of the first potential for determining whether or not the operation state has made a transition to the first state in which the electronic pen 3 is pressing the pen sensor 10, according to the movement speed of the electronic pen 3 with respect to the pen sensor 10. Hence, the sensor controller 20 can calculate the pen pressure of the electronic pen 3 on the pen sensor 10 with high accuracy even when the accuracy of detection of the position of the electronic pen 3 by the pen sensor 10 changes according to the magnitude of the movement speed of the electronic pen 3.

In addition, the pen pressure calculating section 23 sets the value of the first potential to the value of the third potential when the movement speed is equal to or higher than the speed threshold value. In addition, the pen pressure calculating section 23 sets the value of the first potential to the value of the fourth potential higher than the third potential when the movement speed is lower than the speed threshold value.

The accuracy of detection of the position signal by the detection electrodes 11 and 12 may decrease when the electronic pen 3 moves at a speed equal to or higher than the speed threshold value. Such a decrease in the detection accuracy occurs because the electronic pen 3 may be located precisely in a gap between a plurality of detection electrodes 11 or detection electrodes 12 in timing in which the position signal is detected when the electronic pen 3 is moving rapidly. According to this configuration, the sensor controller 20 sets the value of the first potential to the value of the third potential lower than the fourth potential when the electronic pen 3 is moving on the pen sensor 10 at a speed equal to or higher than the speed threshold value and thus the accuracy of detection of the position signal by the pen sensor 10 decreases. In other words, the sensor controller 20 relaxes the reference for determining whether or not the operation state has made a transition to the first state. Hence, the sensor controller 20 can calculate the pen pressure of the electronic pen 3 on the pen sensor 10 with high accuracy even when the movement speed of the electronic pen 3 is equal to or higher than the speed threshold value.

Incidentally, while the sensor controller 20 determines the first potential and the second potential according to whether or not the movement speed of the electronic pen 3 is equal to or higher than the speed threshold value in the fifth embodiment, the sensor controller 20 is not limited to this. The sensor controller 20 may store a plurality of speed threshold values in the storage section 21 regarding the movement speed of the electronic pen 3. In addition, the sensor controller 20 may determine the first potential and the second potential according to conditions determined by the plurality of speed threshold values. Here, a description will be made by taking as an example a case where the storage section 21 stores two speed threshold values.

The storage section 21 stores a first speed threshold value and a second speed threshold value, where the second speed threshold value is a value higher than the first speed threshold value. In addition, the storage section 21 stores, regarding the first potential, a potential in a case where the movement speed of the electronic pen 3 is lower than the first speed threshold value, a potential in a case where the movement speed of the electronic pen 3 is equal to or higher than the first speed threshold value and lower than the second speed threshold value, and a potential in a case where the movement speed of the electronic pen 3 is equal to or higher than the second speed threshold value. In addition, the storage section 21 stores, regarding the second potential, a potential in a case where the movement speed of the electronic pen 3 is lower than the first speed threshold value, a potential in a case where the movement speed of the electronic pen 3 is equal to or higher than the first speed threshold value and lower than the second speed threshold value, and a potential in a case where the movement speed of the electronic pen 3 is equal to or higher than the second speed threshold value.

The pen pressure calculating section 23 determines which of a plurality of conditions the movement speed of the electronic pen 3 satisfies, where the plurality of conditions are determined by the first speed threshold value and the second speed threshold value. When the movement speed of the electronic pen 3 is lower than the first speed threshold value, the pen pressure calculating section 23 sets the values of the first potential and the second potential to the respective potentials in the case where the movement speed of the electronic pen 3 is lower than the first speed threshold value. In addition, when the movement speed of the electronic pen 3 is equal to or higher than the first speed threshold value and lower than the second speed threshold value, the pen pressure calculating section 23 sets the values of the first potential and the second potential to the respective potentials in the case where the movement speed of the electronic pen 3 is equal to or higher than the first speed threshold value and lower than the second speed threshold value. When the movement speed of the electronic pen 3 is equal to or higher than the second speed threshold value, the pen pressure calculating section 23 sets the values of the first potential and the second potential to the respective potentials in the case where the movement speed of the electronic pen 3 is equal to or higher than the second speed threshold value.

According to this configuration, the sensor controller 20 adjusts a degree of relaxation of the reference for determining whether or not the operation state has made a transition, to three levels or more according to the movement speed of the electronic pen 3. Hence, the sensor controller 20 can calculate the pen pressure of the electronic pen 3 on the pen sensor 10 with higher accuracy according to the movement speed of the electronic pen 3.

In addition, while the sensor controller 20 determines the values of the first potential and the second potential according to whether or not the movement speed of the electronic pen 3 satisfies the conditions determined by the speed threshold values, the sensor controller 20 is not limited to this. The sensor controller 20 may substitute the movement speed of the electronic pen 3 into a function defined for the first potential, and set an output result of the function as the first potential. In addition, the sensor controller 20 may substitute the movement speed of the electronic pen 3 into a function defined for the second potential, and set an output result of the function as the second potential. The functions are linear functions, for example. Specifically, via the pen pressure calculating section 23, the sensor controller 20 may determine the first potential in such a manner as to be proportional to the movement speed of the electronic pen 3. In addition, via the pen pressure calculating section 23, the sensor controller 20 may determine the second potential in such a manner as to be proportional to the movement speed of the electronic pen 3.

According to this configuration, the sensor controller 20 can calculate the pen pressure of the electronic pen 3 on the pen sensor 10 with higher accuracy according to the movement speed of the electronic pen 3.

In addition, while the sensor controller 20 determines the values of the first potential and the second potential according to the movement speed of the electronic pen 3, the sensor controller 20 is not limited to this. The sensor controller 20 may determine the first value by the pen pressure calculating section 23 according to the movement speed of the electronic pen 3. In addition, the sensor controller 20 may determine the second value by the pen pressure calculating section 23 according to the movement speed of the electronic pen 3. Specifically, when the movement speed of the electronic pen 3 is equal to or higher than the speed threshold value, the pen pressure calculating section 23 sets the first value to a third value (relaxed value). In addition, when the movement speed of the electronic pen 3 is lower than the speed threshold value, the pen pressure calculating section 23 sets the first value to a fourth value (value as usual) lower than the third value. In addition, when the movement speed of the electronic pen 3 is equal to or higher than the speed threshold value, the pen pressure calculating section 23 sets the second value to a fifth value (relaxed value). In addition, when the movement speed of the electronic pen 3 is lower than the speed threshold value, the pen pressure calculating section 23 sets the second value to a sixth value (value as usual) lower than the fifth value.

According to this configuration, the sensor controller 20 determines the first value or the second value used as a result of calculation of the pen pressure value, according to the movement speed of the electronic pen 3 with respect to the pen sensor 10. Specifically, when the movement speed of the electronic pen 3 is equal to or higher than the speed threshold value, the sensor controller 20 calculates the pen pressure value to be a large value as compared with the case where the movement speed of the electronic pen 3 is lower than the speed threshold value. Hence, the sensor controller 20 can calculate the pen pressure of the electronic pen 3 on the pen sensor 10 with high accuracy even when the accuracy of detection of the position of the electronic pen 3 by the pen sensor 10 changes according to the magnitude of the movement speed of the electronic pen 3.

### Sixth Embodiment

A sixth embodiment will next be described.

In the sixth embodiment, the sensor controller 20 performs wait processing when a movement distance of the electronic pen 3 is short and an elapsed time is short after a previous calculation of the pen pressure value of the electronic pen 3. Specifically, the pen pressure calculating section 23 calculates the movement distance by which the electronic pen 3 has been moved since the previous calculation of the pen pressure value of the electronic pen 3. In addition, the pen pressure calculating section 23 measures a time elapsed since the calculation processing of the pen pressure value. Then, when the movement distance of the electronic pen 3 is less than a reference distance and the elapsed time is less than a reference time after the previous calculation of the pen pressure value of the electronic pen 3, the pen pressure calculating section 23 performs the wait processing for a predetermined wait time. The wait processing includes stopping a series of processing regarding the calculation of the pen pressure value for a set time. Incidentally, the storage section 21 stores values of the reference time, the reference distance, and the wait time.

### Flow of Series of Operations

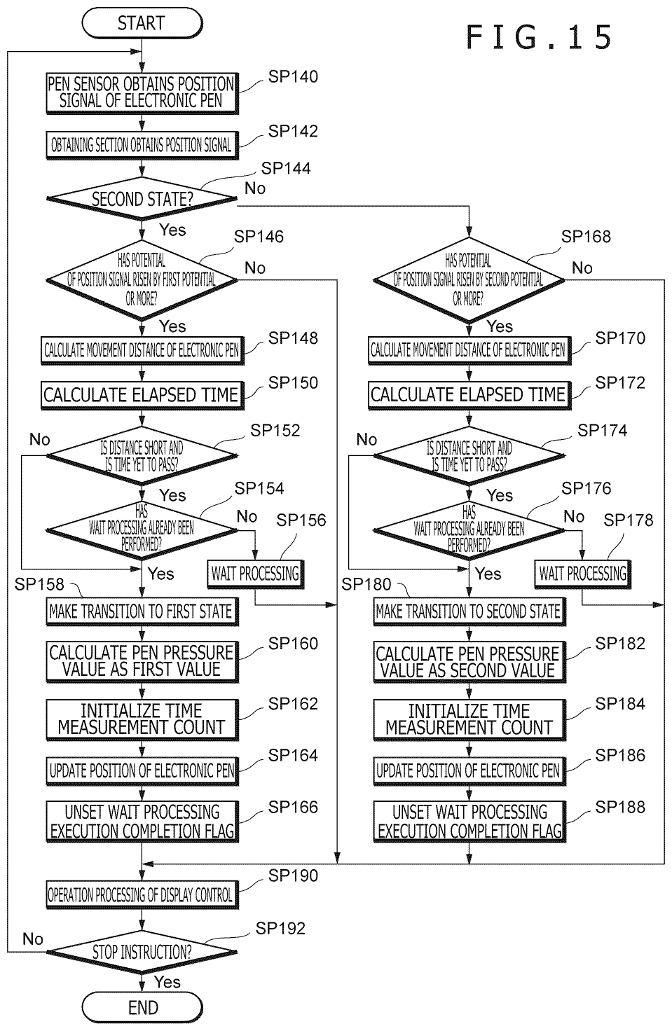

Here, a flow of specific processing of the electronic apparatus 1A in the sixth embodiment will be described with reference to FIG. 15. FIG. 15 is a flowchart illustrating an example of a flow of a series of processing by the electronic apparatus 1A according to the sixth embodiment. Incidentally, in FIG. 15, the processing of steps SP140 to SP146 and step SP168 is the same processing as the processing of steps SP10 to SP16 and step SP22 in the first embodiment, and therefore, a description thereof will be omitted here. In addition, in FIG. 15, the processing of steps SP158 to SP160 is the same processing as the processing of steps SP18 to SP20 in the first embodiment, and therefore, a description thereof will be omitted here. In addition, in FIG. 15, the processing of step SP168 and step SP190 is respectively the same processing as the processing of step SP22 and step SP28 in the first embodiment, and therefore, a description thereof will be omitted here. In addition, the processing of steps SP170 to SP178 in FIG. 15 is the same as the processing of steps SP148 to SP156 to be described later, and therefore, a description thereof will be omitted. In addition, the processing of steps SP180 to SP182 in FIG. 15 is the same as the processing of steps SP24 to SP26 in the first embodiment, and therefore, a description thereof will be omitted. In addition, the processing of steps SP184 to SP188 in FIG. 15 is the same as the processing of steps SP162 to SP166 to be described later, and therefore, a description thereof will be omitted.

### (Step SP148)

Via the pen pressure calculating section 23, the electronic apparatus 1A calculates the movement distance of the electronic pen 3 with respect to the pen sensor 10 from the position signal obtained by the obtaining section 22. Specifically, the electronic apparatus 1A performs processing similar to the processing of step SP114 in the fifth embodiment, thereby calculating a difference between a coordinate value of the electronic pen 3 on the pen sensor 10 which coordinate value is extracted from the present position signal and the coordinate value extracted previously. Via the pen pressure calculating section 23, the electronic apparatus 1A sets a result of the calculation as the movement distance. The processing then proceeds to the processing of step SP150.

### (Step SP150)

Via the pen pressure calculating section 23, the electronic apparatus 1A calculates the time elapsed since a previous calculation of the pen pressure value. A time point serving as a starting point of the elapsed time is set in the processing of step SP162 to be described later. Incidentally, when the electronic apparatus 1A has not performed the processing of calculating the pen pressure value, the electronic apparatus 1A omits the processing of calculating the elapsed time. The processing then proceeds to the processing of step SP152.

### (Step SP152)

Via the pen pressure calculating section 23, the electronic apparatus 1A determines whether or not the distance traveled by the electronic pen 3 since the previous calculation of the pen pressure value is less than the reference distance and the time elapsed since the previous calculation of the pen pressure value is less than the reference time. Then, when the determination is a positive determination, the processing proceeds to the processing of step SP154. When the determination is a negative determination, on the other hand, the processing proceeds to the processing of step SP158.

### (Step SP154)

Via the pen pressure calculating section 23, the electronic apparatus 1A determines whether or not the wait processing has already been performed. Specifically, via the pen pressure calculating section 23, the electronic apparatus 1A determines whether or not a wait processing execution completion flag is set. The wait processing execution completion flag is stored in the storage section 21, for example. Then, when the determination is a positive determination, the processing proceeds to the processing of step SP158. When the determination is a negative determination, on the other hand, the processing proceeds to the processing of step SP156.

### (Step SP156)

Via the pen pressure calculating section 23, the electronic apparatus 1A performs the wait processing. Specifically, via the pen pressure calculating section 23, the electronic apparatus 1A stops the series of processing operations for the wait time. Next, via the pen pressure calculating section 23, the electronic apparatus 1A sets the wait processing execution completion flag. The processing then proceeds to the processing of step SP190.

### (Step SP162)

Via the pen pressure calculating section 23, the electronic apparatus 1A initializes a count for measuring the time elapsed since the previous calculation of the pen pressure value. Specifically, when a time measurement of the time elapsed since the previous calculation of the pen pressure value is being performed, the electronic apparatus 1A ends the time measurement by the pen pressure calculating section 23. Next, via the pen pressure calculating section 23, the electronic apparatus 1A starts a time measurement of the elapsed time from the present calculation of the pen pressure value with a present time point as a starting time point. The processing then proceeds to the processing of step SP164.

### (Step SP164)

Via the pen pressure calculating section 23, the electronic apparatus 1A updates the position of the electronic pen 3 on the pen sensor 10. Specifically, via the pen pressure calculating section 23, the electronic apparatus 1A updates the coordinate value of the position of the electronic pen 3 at a time of performing the processing of calculating the pen pressure value, with the present coordinate value of the electronic pen 3 extracted in the processing of step SP148. The processing then proceeds to the processing of step SP166.

### (Step SP166)

Via the pen pressure calculating section 23, the electronic apparatus 1A unsets the wait processing execution completion flag. Incidentally, when the wait processing execution completion flag is already in an unset state, the electronic apparatus 1A maintains the wait processing execution completion flag in the unset state as it is. The processing then proceeds to the processing of step SP190.

### Effects

As described above, in the sixth embodiment, the pen pressure calculating section 23 calculates the pen pressure value when a predetermined condition is not satisfied. Here, the predetermined condition is a condition that the time elapsed since the previous calculation of the pen pressure value is less than the reference time and the distance traveled by the electronic pen 3 since the previous calculation of the pen pressure value is less than the reference distance.

According to this configuration, the sensor controller 20 calculates the pen pressure value when (1) the distance traveled by the electronic pen 3 since a calculation of the pen pressure value is long or (2) the time elapsed since the calculation of the pen pressure value is long. Thus, the sensor controller 20 does not calculate the pen pressure value in a case where, for example, the electronic pen 3 moves only in an upward-downward direction (direction normal to the detecting surface) above the pen sensor 10 during a short time. Hence, the sensor controller 20 can be inhibited from calculating the pen pressure value in a case where the electronic pen 3 is only shaking above the pen sensor 10 due to a tremor of the hand, a habit, or the like when the user performs drawing with the electronic pen 3. In addition, when there is a deviation from a motion possible for a human, such as a change in signal level during a short time, the sensor controller 20 determines that an erroneous detection of the electronic pen 3 by the pen sensor 10 has occurred, and does not calculate the pen pressure value. Hence, the sensor controller 20 can calculate the pen pressure of the electronic pen 3 on the pen sensor 10 with higher accuracy.

In addition, in the sixth embodiment, when the predetermined condition is satisfied, the pen pressure calculating section 23 performs the wait processing of making the processing wait for the wait time in a case where the wait processing has not been performed after a previous determination for the predetermined condition. On the other hand, when the predetermined condition is satisfied, the pen pressure calculating section 23 calculates the pen pressure value in a case where the wait processing has been performed after the previous determination for the predetermined condition.

According to this configuration, the sensor controller 20 performs the wait processing when the predetermined condition is satisfied (when the distance traveled by the electronic pen 3 since a calculation of the pen pressure value is short and the time elapsed since the calculation of the pen pressure value is short). Thus, even when an amount of change in the signal level varies at substantially the same position in a short time, the sensor controller 20 determines that the variation is caused by an erroneous detection or a hand tremor, a habit, or the like, of the user, and the sensor controller 20 makes the calculation of the pen pressure value wait. Hence, the sensor controller 20 can calculate the pen pressure of the electronic pen 3 on the pen sensor 10 with higher accuracy.

Incidentally, the sensor controller 20 may determine whether or not to calculate the pen pressure value, depending on the position of the electronic pen 3 in the upward-downward direction (direction normal to the detecting surface) with respect to the pen sensor 10. Specifically, by the pen pressure calculating section 23, the sensor controller 20 extracts a coordinate value indicating the position of the electronic pen 3 in the direction normal to the detecting surface (that is, the height of the electronic pen 3) with respect to the pen sensor 10 from the position signal. By the pen pressure calculating section 23, the sensor controller 20 calculates the pen pressure value when the extracted coordinate value is less than a reference height. On the other hand, by the pen pressure calculating section 23, the sensor controller 20 does not calculate the pen pressure value when the extracted coordinate value is equal to or more than the reference height. The reference height is stored in the storage section 21, for example.

According to this configuration, when the position of the electronic pen 3 is high with respect to the pen sensor 10, the sensor controller 20 does not calculate the pen pressure value irrespective of amounts of change in the signal level. Hence, the sensor controller 20 suppresses an erroneous detection in a case where the electronic pen 3 is at such a height that the electronic pen 3 cannot be in contact with the pen sensor 10, and there is a large amount of change in the signal level. Hence, the sensor controller 20 can calculate the pen pressure of the electronic pen 3 on the pen sensor 10 with higher accuracy.

### Seventh Embodiment

A seventh embodiment will next be described.

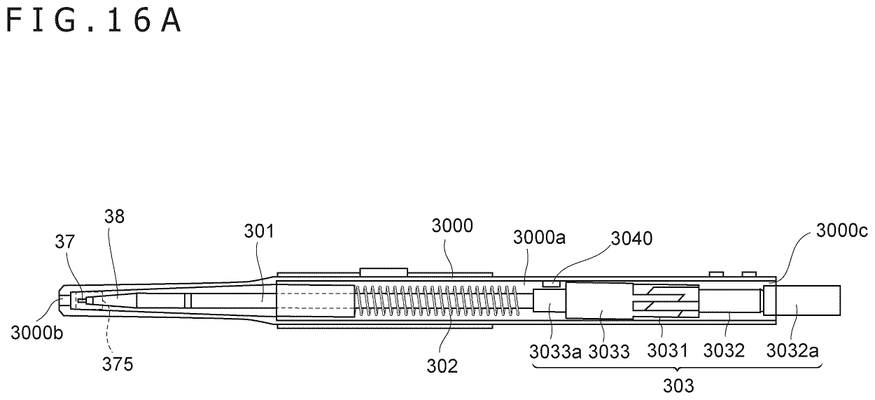

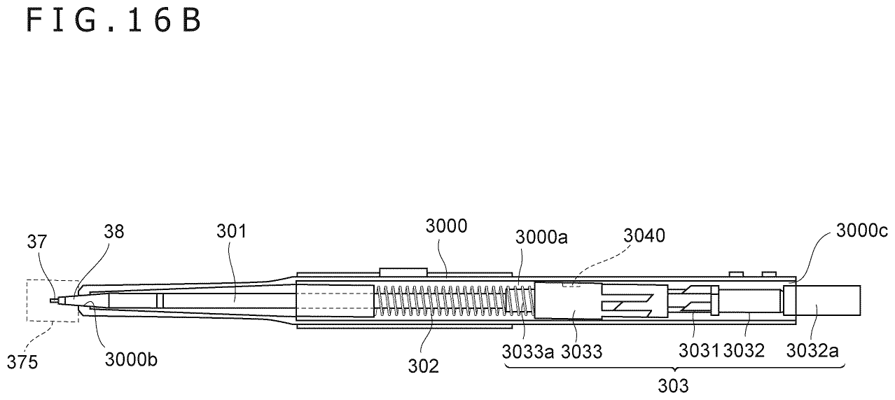

FIG. 16A is a diagram illustrating a state in which a pen tip 375 of an electronic pen 3 according to the seventh embodiment is housed within a hollow portion 3000a of a casing 3000. In addition, FIG. 16B is a diagram illustrating a state in which the pen tip 375 of the electronic pen 3 according to the seventh embodiment is protruded from an opening portion 3000b of the casing 3000. Incidentally, FIG. 16A and FIG. 16B illustrate the electronic pen 3 in a state in which it is assumed that the casing 3000 of the electronic pen 3 is formed of a transparent synthetic resin and thus the components inside of the casing 3000 can be seen. The casing 3000 functions as a housing member for housing the pen tip 375. In addition, in FIG. 16A and FIG. 16B, the casing 3000 and a knock mechanism 303 provided within the casing 3000 are configured in a manner similar to that of a well-known commercially available knock type ballpoint pen.

The knock mechanism 303 is a protruding and retracting member that enables the pen tip 375 to be protruded from and retracted into the opening portion 3000b on one side of the casing 3000. The knock mechanism 303 is formed by combining a cam main body 3031, a knock rod 3032, and a rotor 3033. The cam main body 3031 is formed on an inner wall surface of the casing 3000 in a tubular shape. The knock rod 3032 is configured to be able to receive a knock operation made by the user of the electronic pen 3. An end portion 3032a is provided to project from an opening portion 3000c on a side opposite to the pen tip 375 side of the casing 3000. The rotor 3033 is provided with a fitting portion 3033a fitted with a rear end portion of a main body portion 301 where the rear end portion is on a side opposite to the pen tip 375 side. The cam main body 3031 and the rotor 3033 function as a sliding member that slidingly moves according to the knock operation on the knock rod 3032.

In the electronic pen 3, when the end portion 3032a of the knock rod 3032 is depressed in a state illustrated in FIG. 16A, the knock mechanism 303 locks the main body portion 301 to a state illustrated in FIG. 16B within the casing 3000. That is, the pen tip 375 of the main body portion 301 is set in a state of being protruded from the opening portion 3000b of the casing 3000. In addition, in the electronic pen 3, when the end portion 3032a of the knock rod 3032 is depressed again from the state of FIG. 16B, the knock mechanism 303 releases the locked state. Thus, the position of the main body portion 301 within the casing 3000 is returned to the state of FIG. 16A by a return spring 320. Incidentally, a detailed configuration of the knock mechanism 303 and operations thereof are well known, and therefore, a description thereof will be omitted here.

In addition, the electronic pen 3 includes a switch member 3040 for determining whether or not the pen tip 375 is housed within the casing 3000. The switch member 3040 is provided to an inner wall of the casing 3000. The switch member 3040 has a movable part (not illustrated) that is movable along the axial direction of the electronic pen 3. The movable part moves in a manner interlocked with a movement of the fitting portion 3033a or the rotor 3033 in the axial direction. A state of the switch member 3040 is switched when the movable part moves in a manner interlocked with a sliding movement of the fitting portion 3033a caused by a knock operation on the knock mechanism 303.

The electronic pen 3 includes a pen controller 36 within the main body portion 301. The pen controller 36 determines a housing state on the basis of a change in the state of the switch member 3040. Specifically, when the movable part of the switch member 3040 is positioned on the pen tip 375 side, the pen controller 36 determines that the pen tip 375 is in a state of not being housed as in FIG. 16B. On the other hand, when the movable part of the switch member 3040 is positioned on the knock rod 3032 side, the pen controller 36 determines that the pen tip 375 is in a state of being housed as in FIG. 16A. Incidentally, suppose that the switch member 3040 switches an electric conduction state of the switch member 3040 to on or off according to the position of the movable part. Then, the pen controller 36 determines the on/off state as the electric conduction state of the switch member 3040 by applying a potential to the switch member 3040 and measuring a current value or a resistance value. The pen controller 36 thus determines the state of the switch member 3040.

In addition, the pen controller 36 transmits and receives signals, such as a position signal, to and from the pen sensor 10 via an electrode 37 or 38 provided to the pen tip 375. A signal transmitted from the electronic pen 3 to the pen sensor 10 is a downlink signal to the pen sensor 10. Alternatively, a signal transmitted from the pen sensor 10 to the electronic pen 3 is an uplink signal. As discussed above, the pen controller 36 determines the state of the switch member 3040. When the state of the switch member 3040 has changed, the pen controller 36 notifies the pen sensor 10 of the determination result via the electrode 37 or 38. In addition, the pen controller 36 receives a response to the notification from the pen sensor 10 via the electrode 37 or 38. Then, the pen controller 36 stops the transmission of the signal to the pen sensor 10.

Here, operations of the pen sensor 10 and the sensor controller 20 in the seventh embodiment will be described. The pen sensor 10 transmits and receives the signals to and from the electronic pen 3 according to operation control of the sensor controller 20. The sensor controller 20 controls an operation of position detection by the pen sensor 10. The sensor controller 20 receives a notification from the electronic pen 3 when the housing state of the pen tip 375, with respect to the housing member (casing 3000 in the present example), has changed. When the notification indicates that the housing state of the pen tip 375 has changed to a state of being housed in the housing member, the sensor controller 20 responds to the electronic pen 3 so as to stop the transmission of the downlink signal to the pen sensor 10. On the other hand, when the notification indicates that the housing state of the pen tip 375 has changed to a state of not being housed in the housing member, the sensor controller 20 responds to the electronic pen 3 so as to start the transmission of the downlink signal to the pen sensor 10. Incidentally, the sensor controller 20 responds by transmitting the uplink signal from the pen sensor 10 to the electronic pen 3.

The description now returns to that of the pen controller 36. When the pen controller 36 has transmitted a notification indicating that the pen tip 375 is housed to the pen sensor 10, the pen controller 36 receives, from the pen sensor 10, a response indicating that the transmission of the signal to the pen sensor 10 is to be stopped. Then, the pen controller 36 stops the transmission of the signal to the pen sensor 10. In addition, when the pen controller 36 has transmitted a notification indicating that the pen tip 375 is not housed to the pen sensor 10, the pen controller 36 receives, from the pen sensor 10, a response indicating that the transmission of the signal to the pen sensor 10 is to be started. Then, the pen controller 36 starts the transmission of the signal to the pen sensor 10.

It is to be noted that, while the electronic pen 3 uses the downlink signal and the uplink signal for the transmission of a notification to the pen sensor 10 and the reception of a response to the notification from the pen sensor 10, the electronic pen 3 is not limited to this. For the transmission of a notification and the reception of a response to the notification, the electronic pen 3 may transmit and receive signals by short-range wireless communication such as Bluetooth (registered trademark) rather than the uplink signal and the downlink signal.

### Flow of Series of Operations

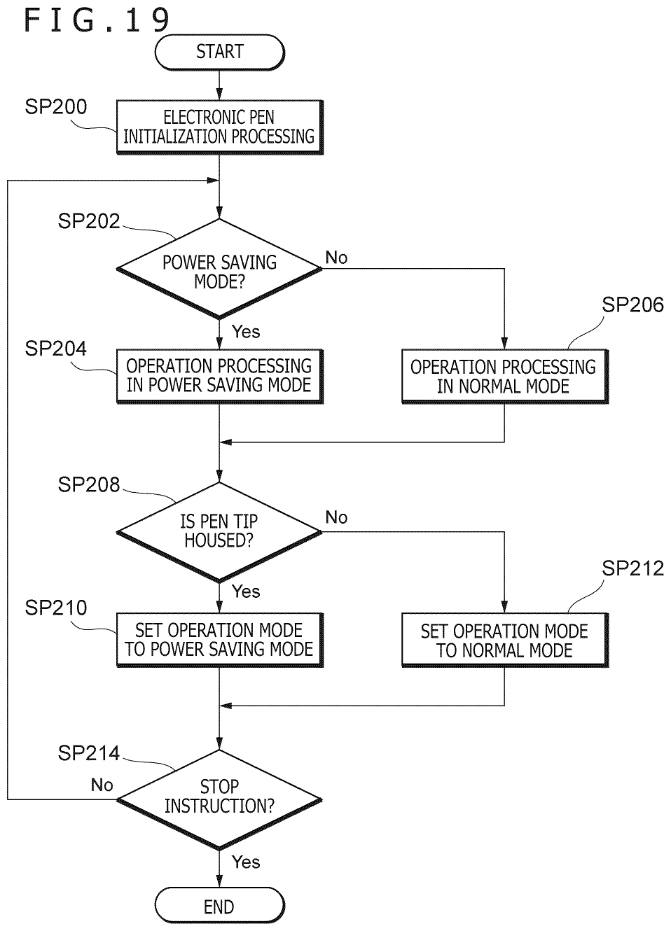

Here, a flow of specific processing of the electronic pen 3 in the seventh embodiment will be described with reference to FIG. 19. FIG. 19 is a flowchart illustrating an example of a flow of a series of processing by the electronic pen 3 according to the seventh embodiment.

### (Step SP200)

Via the pen controller 36, the electronic pen 3 performs initialization processing. In the initialization processing, the electronic pen 3 temporarily sets an operation mode to a normal mode, for example. The electronic pen 3 has, for example, the normal mode and a power saving mode as operation modes, and operates in one of the operation modes. The power saving mode is an operation mode in which power consumption of the electronic pen 3 is suppressed. The normal mode is an operation mode in which the power consumption of the electronic pen 3 is not suppressed as compared with the power saving mode. The processing then proceeds to the processing of step SP202.

### (Step SP202)

Via the pen controller 36, the electronic pen 3 determines whether or not the operation mode is the power saving mode. Then, when the determination is a positive determination, the processing proceeds to the processing of step SP204. When the determination is a negative determination, on the other hand, the processing proceeds to the processing of step SP206.

### (Step SP204)

The electronic pen 3 performs operation processing in the power saving mode. In the power saving mode, the electronic pen 3, for example, stops the transmission of the signal to the pen sensor 10. In addition, in the power saving mode, the electronic pen 3, for example, decreases a frequency of the transmission of the signal to the pen sensor 10 as compared with the normal mode. In addition, the electronic pen 3 receives the signal from the pen sensor 10. When the electronic pen 3 is transmitting the signal to the pen sensor 10, the electronic pen 3 communicates information regarding the position of the electronic pen 3 with respect to the pen sensor 10 and the pen pressure to the pen sensor 10 by transmitting and receiving the signals to and from the pen sensor 10. The processing then proceeds to the processing of step SP208.

### (Step SP206)

The electronic pen 3 performs operation processing in the normal mode. In the normal mode, the electronic pen 3, for example, transmits the signal to the pen sensor 10 at predetermined intervals. In addition, in the normal mode, the electronic pen 3 receives the signal from the pen sensor 10. The electronic pen 3 communicates information regarding the position of the electronic pen 3 with respect to the pen sensor 10 and the pen pressure to the pen sensor 10 by transmitting and receiving the signals to and from the pen sensor 10. The processing then proceeds to the processing of step SP208.

### (Step SP208)

Via the pen controller 36, the electronic pen 3 determines whether or not the pen tip 375 is housed in the housing member. Then, when the determination is a positive determination, the processing proceeds to the processing of step SP210. When the determination is a negative determination, on the other hand, the processing proceeds to the processing of step SP212.

### (Step SP210)

When the operation mode is the normal mode, the electronic pen 3 transmits a notification indicating that the pen tip 375 is housed in the housing member to the pen sensor 10 via the pen controller 36. Next, via the pen controller 36, the electronic pen 3 receives a response to the notification, from the pen sensor 10. The response transmitted from the pen sensor 10 to the electronic pen 3 includes a control instruction to switch the operation mode of the electronic pen 3 from the normal mode to the power saving mode. The electronic pen 3 switches the operation mode from the normal mode to the power saving mode according to the control instruction indicated by the response received from the pen sensor 10. Incidentally, when the operation mode is already the power saving mode, the electronic pen 3 does not transmit the notification to the pen sensor 10. In addition, when the operation mode is already the power saving mode, the electronic pen 3 maintains the operation mode as the power saving mode as it is. The processing then proceeds to the processing of step SP214.

### (Step SP212)

When the operation mode is the power saving mode, the electronic pen 3 transmits a notification indicating that the pen tip 375 is not housed in the housing member to the pen sensor 10 via the pen controller 36. Next, via the pen controller 36, the electronic pen 3 receives a response to the notification, from the pen sensor 10. The response transmitted from the pen sensor 10 to the electronic pen 3 includes a control instruction to switch the operation mode of the electronic pen 3 from the power saving mode to the normal mode. The electronic pen 3 switches the operation mode from the power saving mode to the normal mode according to the control instruction indicated by the response received from the pen sensor 10. Incidentally, when the operation mode is already the normal mode, the electronic pen 3 does not transmit the notification to the pen sensor 10. In addition, when the operation mode is already the normal mode, the electronic pen 3 maintains the operation mode as the normal mode as it is. The processing then proceeds to the processing of step SP214.

### (Step SP214)

Via the pen controller 36, the electronic pen 3 determines whether or not an instruction to stop the operation of the electronic pen 3 is received through an operating input by the user of the electronic pen 3, a signal transmitted from the pen sensor 10, or the like. The stopping of the operation is, for example, the turning off of power to the electronic pen 3. Then, when the determination is a negative determination, the processing returns to the processing of step SP202. When the determination is a positive determination, on the other hand, the electronic pen 3 stops the operation of the electronic pen 3 via the pen controller 36. The flow of the series of processing illustrated in FIG. 19 is then ended.

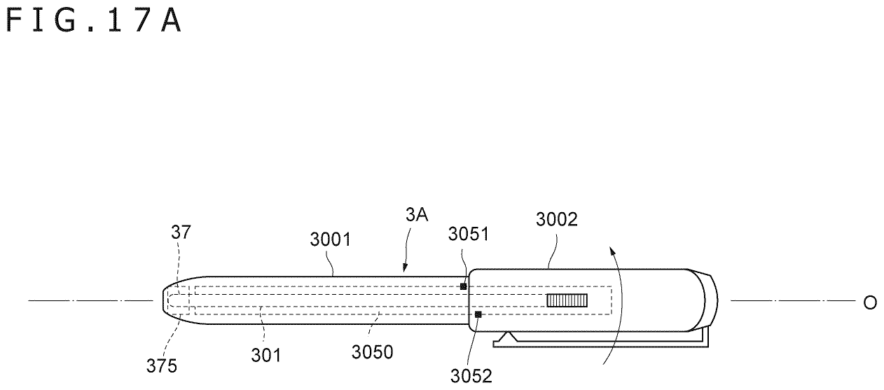

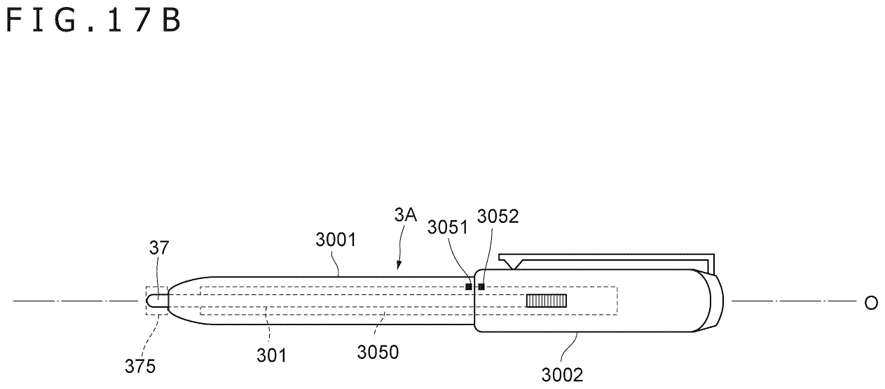

Another example of the electronic pen 3 according to the seventh embodiment will be described. FIG. 17A is a diagram illustrating a state in which the pen tip 375 of a rotary type electronic pen 3 according to the seventh embodiment is housed within a hollow portion of the casing 3000. In addition, FIG. 17B is a diagram illustrating a state in which the pen tip 375 of the rotary type electronic pen 3 according to the seventh embodiment is protruded from the opening portion 3000b of the casing 3000.

As illustrated in FIG. 17A and FIG. 17B, the electronic pen 3 includes a casing 3001 and a casing 3002 that is rotatably fitted to the casing 3001 with a center line O of the casing 3001 as a rotational axis. The casing 3001 functions as a housing member capable of housing the pen tip 375. In addition, the casing 3001 includes a protruding and retracting mechanism 3050 that protrudes and retracts the pen tip 375 of the main body portion 301 in a rotary manner. The main body portion 301 is inserted into the protruding and retracting mechanism 3050 and is further held by the protruding and retracting mechanism 3050. The casing 3002 is fitted to the protruding and retracting mechanism 3050 and has a configuration that applies a rotation to the protruding and retracting mechanism 3050. Incidentally, in FIG. 17A and FIG. 17B, the main body portion 301 has a fitting portion fixed to the protruding and retracting mechanism 3050 by being inserted into the protruding and retracting mechanism 3050.

The casing 3001 is provided with a detecting member 3051 at a position close to the casing 3002. In addition, the casing 3002 is provided with a detecting member 3052 at a position close to the casing 3001. The detecting member 3051 is a magnet, for example. In addition, the detecting member 3052 is a magnetic sensor, for example. In a state in which the pen tip 375 is housed in the casing 3001 as in FIG. 17A, the detecting member 3052 of the casing 3002 is separated from the detecting member 3051 of the casing 3001. In this case, a sensor output of the detecting member 3052 is at a low level because a detection level of a magnetic force originating from the detecting member 3051 is weakened. On the other hand, in a state in which the pen tip 375 is not housed in the casing 3001 as in FIG. 17B, the detecting member 3052 of the casing 3002 is in proximity to the detecting member 3051 of the casing 3001. In this case, the sensor output of the detecting member 3052 is at a high level because a strong magnetic force originating from the detecting member 3051 is detected.

The electronic pen 3 has the pen controller 36 provided in the main body portion 301. The pen controller 36 determines whether or not the pen tip 375 is housed in the casing 3001, according to a value of the sensor output of the detecting member 3052. Incidentally, a flow of processing by the pen controller 36 is as described above, and therefore, a description thereof will be omitted here.

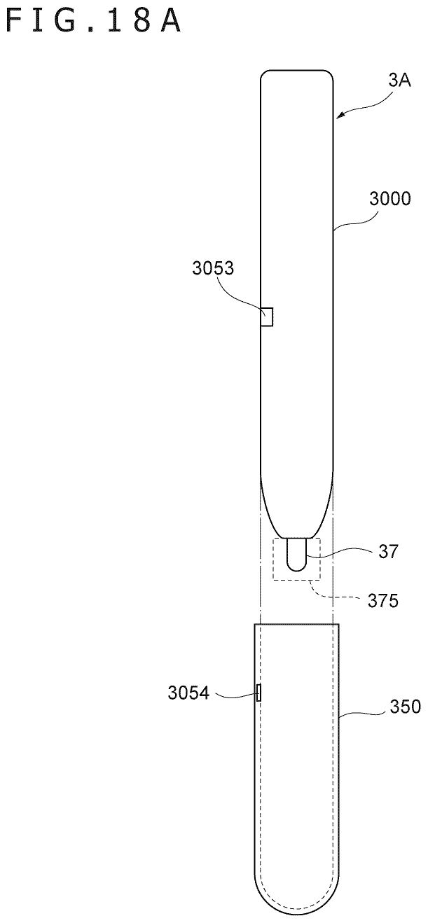

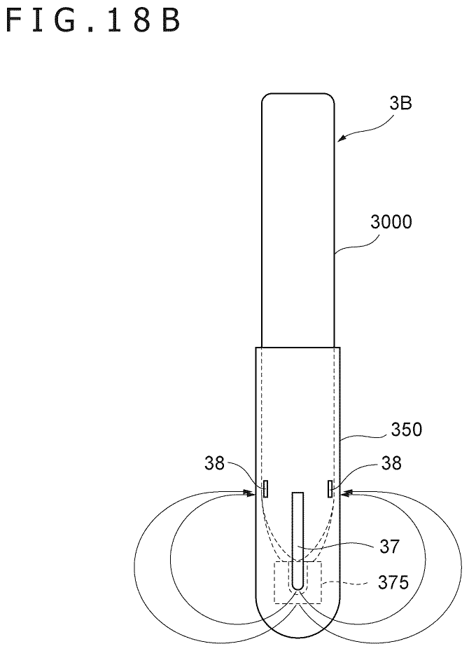

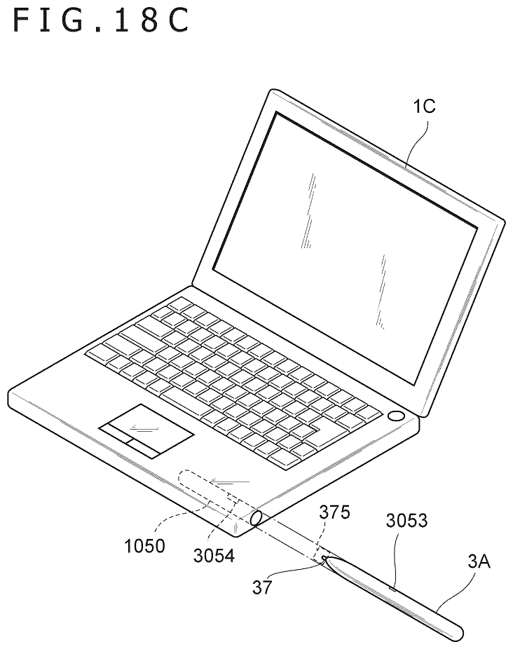

Another example of the electronic pen 3 according to the seventh embodiment will be described. FIG. 18A is a diagram illustrating an example of a configuration of a cap type electronic pen 3A according to the seventh embodiment. As illustrated in FIG. 18A, the electronic pen 3A has a casing 3000 and a cap 350. The cap 350 is a housing member capable of housing the pen tip 375. Specifically, the cap 350 is a housing member detachably fitted to the casing 3000 in such a manner as to cover the pen tip 375 of the electronic pen 3A, the casing 3000 being provided with the pen tip 375.

In FIG. 18A, the casing 3000 has a detecting member 3053 that detects whether or not the pen tip 375 is housed in the cap 350. The detecting member 3053 is provided to an outer periphery of the casing 3000. The detecting member 3053 is positioned such that it comes into contact with a detecting member 3054 provided to an inner wall of the cap 350 when the cap 350 is fitted to the casing 3000.

The cap 350 has the detecting member 3054 that detects whether or not the pen tip 375 is housed in the cap 350. The detecting member 3054 is provided to an inner periphery of the cap 350. The detecting member 3054 is positioned such that it comes into contact with the detecting member 3053 of the casing 3000 when the cap 350 is fitted to the casing 3000.

The detecting members 3053 and 3054 are, for example, physical switch members, electrodes, magnets, or the like. A case where the detecting members 3053 and 3054 are switch members will now be described. The detecting member 3053 has a button that can be depressed in a direction normal to the outer periphery of the casing 3000. The detecting member 3054 is formed as a protrusion that extends in an inward direction of the cap 350 from the inner periphery of the cap 350. When the cap 350 is fitted to the casing 3000, the detecting member 3054 depresses the detecting member 3053. When the cap 350 is removed from the casing 3000, on the other hand, the detecting member 3053 is released from the depression by the detecting member 3054. The pen controller 36 of the electronic pen 3A determines whether or not the pen tip 375 is housed in the cap 350, according to whether or not the button of the detecting member 3053 is depressed. Incidentally, a depression state of the button of the detecting member 3053 is determined by, for example, measuring a current flowing through a detecting electric circuit formed between the pen controller 36 and the button or the like.

A case where the detecting members 3053 and 3054 are electrodes will now be described. The detecting member 3053 has, for example, an electrode functioning as an input terminal and an electrode functioning as an output terminal. The detecting member 3054 has one electrode that comes into contact with the input terminal and the output terminal of the detecting member 3053 when the cap 350 is fitted to the casing 3000. When the cap 350 is fitted to the casing 3000, a current path conducts from the output terminal of the detecting member 3053 through the electrode of the detecting member 3054 to the input terminal of the detecting member 3053. When the cap 350 is removed from the casing 3000, on the other hand, the conduction of the current path, as just described, is interrupted. In determining whether or not the pen tip 375 is housed, the pen controller 36 of the electronic pen 3A applies a potential from the pen controller 36 to the output terminal of the detecting member 3053. The pen controller 36 measures the current or potential of the input terminal of the detecting member 3053. The pen controller 36 determines whether or not the pen tip 375 is housed in the cap 350, according to the magnitude of a value of a result of the measurement or the like.

In addition, the detecting member 3053 may be an electrode of a capacitive sensor. The detecting member 3053 is connected to a capacitive type detecting sensor circuit provided to the electronic pen 3A. In addition, in this case, the detecting member 3054 is, for example, a metal or the like. The pen controller 36 detects a capacitance on the periphery of the detecting member 3053 by the detecting sensor circuit. When the cap 350 is fitted to the casing 3000 and thus the detecting member 3053 is in proximity to or in contact with the detecting member 3054, a value of a sensor output of a detecting sensor is increased. On the other hand, when the cap 350 is removed from the casing 3000 and thus the detecting member 3053 is separated from the detecting member 3054, the value of the sensor output of the detecting sensor is decreased. The pen controller 36 determines whether or not the pen tip 375 is housed in the cap 350, according to the magnitude of the sensor output of the detecting sensor or the like.

A case where the detecting member 3053 is a magnet and the detecting member 3054 is a magnetic sensor will now be described. The pen controller 36 measures a sensor output of the magnetic sensor of the detecting member 3054. Incidentally, the determination by the pen controller 36 as to whether or not the pen tip 375 is housed in the cap 350 is the same as in the case where the detecting member 3053 is an electrode of a capacitive sensor except that the measurement target is different. A description thereof will therefore be omitted here.

Yet another example of the electronic pen 3 according to the seventh embodiment will next be described. FIG. 18B is a diagram illustrating another example of a configuration of a cap type electronic pen 3B according to the seventh embodiment.

As illustrated in FIG. 18B, the electronic pen 3B has electrodes 37 and 38. In addition, an inner periphery of the cap 350 is formed so as to conform to the shape of the pen tip 375 such that a space volume between the inner periphery of the cap 350 and the pen tip 375 is reduced when the cap 350 is fitted to the casing 3000.

In determining whether or not the pen tip 375 is housed in the cap 350, the pen controller 36, provided to the electronic pen 3B, transmits a signal from the electrode 37 to the electrode 38. The pen controller 36 receives the signal transmitted from the electrode 37 by the electrode 38. The pen controller 36 then detects whether or not the pen tip 375 is housed in the cap 350, based on an amount of change in the signal level of the signal received by the electrode 38. When the cap 350 is removed from the casing 3000, there is no shielding object that interrupts propagation of the signal between the electrode 37 and the electrode 38 except for the casing 3000. Hence, the signal level received by the electrode 38 is increased when the cap 350 is removed from the casing 3000. When the cap 350 is fitted to the casing 3000, the cap 350 provided between the electrode 37 and the electrode 38 interrupts the propagation of the signal. Hence, the signal level received by the electrode 38 is decreased when the cap 350 is fitted to the casing 3000. The pen controller 36 determines that the housing state of the pen tip 375 has changed when the amount of change in the signal level received by the electrode 38 is large. Specifically, when a value of the signal level received by the electrode 38 is increased sharply, the pen controller 36 determines that the housing state has changed to a state in which the pen tip 375 is not housed in the cap 350. On the other hand, when the value of the signal level received by the electrode 38 is decreased sharply, the pen controller 36 determines that the housing state has changed to a state in which the pen tip 375 is housed in the cap 350.

It is to be noted that, while the electronic pens 3A and 3B have the cap 350 as the housing member for housing the pen tip 375 in the seventh embodiment, the electronic pens 3A and 3B are not limited to this. The housing member is not limited to the cap 350 and instead, may be any member as long as the member can house the pen tip 375. The housing member may be, for example, a casing that has a hole portion for housing the electronic pen 3 provided to a notebook personal computer or the like. This example will be described with reference to FIG. 18C. FIG. 18C is a diagram illustrating an example of a configuration of the electronic pen 3A according to the seventh embodiment and an electronic apparatus 1C that can house the electronic pen 3A.

The electronic apparatus 1C is, for example, an information processing device such as a notebook personal computer, a tablet, or a smart phone. While the electronic apparatus 1C is preferably an information processing apparatus that is easy to carry about, the electronic apparatus 1C may be an information processing device that is difficult to carry about, such as a desktop personal computer. The electronic apparatus 1C is provided with a casing having a hole portion 1050 capable of housing the electronic pen 3A. An inner periphery of the hole portion 1050 is provided with a detecting member 3054 such as is provided to the inner periphery of the cap 350 in FIG. 18A. When the electronic pen 3A is housed in the hole portion 1050 of the electronic apparatus 1C, the electronic pen 3A detects by the detecting member 3053 that the pen tip 375 is housed in the housing member. On the other hand, when the electronic pen 3A is removed from the hole portion 1050 of the electronic apparatus 1C, the electronic pen 3A detects by the detecting member 3053 that the pen tip 375 is not housed in the housing member.

### Effects

As described above, in the seventh embodiment, the electronic pen 3 includes the pen tip 375, which can be housed in the housing member, and the pen controller 36. The pen tip 375 has the electrode 37 that transmits and receives signals to and from the pen sensor 10. In addition, the pen controller 36 transmits and receives the signals to and from the pen sensor 10 via the electrode 37. The pen controller 36 determines the housing state of the pen tip 375 with respect to the housing member, and the pen controller 36 makes a notification to the pen sensor 10 when determining that the pen tip 375 is housed in the housing member. The pen controller 36 then stops the transmission of the signal according to a response to the notification, where the response is transmitted from the pen sensor 10.

According to this configuration, the electronic pen 3 does not independently stop the transmission of the signal, rather, the electronic pen 3 only stops the transmission of the signal according to a response from the pen sensor 10 after making a notification to the pen sensor 10. Hence, the electronic pen 3 shares the housing state of the pen tip 375, with respect to the housing member, with the pen sensor 10. The electronic pen 3 can therefore improve efficiency of the processing related to the electronic pen 3, where the processing is performed by the pen sensor 10. In addition, the electronic pen 3 can reduce power consumption by stopping the transmission of the signal in a state in which the pen tip 375 is housed and the electronic pen 3 is not used by the user.

In addition, the pen controller 36 makes a notification to the pen sensor 10 when the housing state has changed from a state in which the pen tip 375 is housed in the housing member to a state in which the pen tip 375 is not housed in the housing member. The pen controller 36 starts the transmission of the signal according to a response to the notification, where the response is transmitted from the pen sensor 10.

According to this configuration, the electronic pen 3 does not independently start the transmission of the signal, rather, the electronic pen 3 only starts the transmission of the signal according to a response from the pen sensor 10 after making a notification to the pen sensor 10. Hence, the electronic pen 3 shares the housing state of the pen tip 375, with respect to the housing member, with the pen sensor 10. The electronic pen 3 can therefore improve the efficiency of the processing related to the electronic pen 3, where the processing is performed by the pen sensor 10. In addition, the electronic pen 3 starts the transmission of the signal when the pen tip 375 is extracted from the housing member and the electronic pen 3 is thus set in a state of being usable by the user. Thus, use of the electronic pen 3 can be more convenient since the user does not need to take the trouble to perform an operation.

In addition, the electronic pen 3 further includes the housing member, which is the casing 3000 configured in a tubular shape, and the protruding and retracting member that enables the pen tip 375 to be protruded from and retracted into the opening portion 3000b on one side of the casing 3000.

Hence, the electronic pen 3 can improve the efficiency of the processing related to the electronic pen 3, where the processing is performed by the pen sensor 10 even in the case where the pen tip 375 is housed in the casing 3000, which is configured in a tubular shape. In addition, the electronic pen 3 can reduce power consumption even in the case as just described.

In addition, the protruding and retracting member is the knock mechanism 303 that enables the pen tip 375 to be protruded from and retracted into the opening portion 3000b on one side of the casing. In addition, the electronic pen 3 further includes the switch member 3040. The switch member 3040 changes state according to a sliding movement of the sliding member (the cam main body 3031 and the rotor 3033) when the sliding member is slidingly moved in such a manner as to be interlocked with a knock operation of the knock mechanism 303. In addition, the pen controller 36 determines the housing state on the basis of the state of the switch member 3040.

Hence, the electronic pen 3 can improve the efficiency of the processing related to the electronic pen 3, where the processing is performed by the pen sensor 10 even in the case where the pen tip 375 is protruded and retracted by the knock mechanism 303. In addition, the electronic pen 3 can reduce power consumption even in the case as just described.

In addition, the protruding and retracting member includes the protruding and retracting mechanism 3050 that enables the pen tip 375 to be protruded from and retracted into the opening portion 3000b on one side of the casing 3001 by a rotation of a member (casing 3002) that is coupled to the casing 3001 in a manner of being rotatable with the center line O of the casing 3001 as a rotational axis thereof. In addition, the electronic pen 3 further includes the detecting members 3051 and 3052, which change state according to a rotational movement of the protruding and retracting mechanism 3050, the rotational movement being interlocked with the rotation of the member (casing 3002) rotatably coupled to the casing 3001. In addition, the pen controller 36 determines the housing state on the basis of the state of the detecting members 3051 and 3052.

Hence, the electronic pen 3 can improve the efficiency of the processing related to the electronic pen 3, where the processing is performed by the pen sensor 10 even in the case where the pen tip 375 is protruded or retracted by a rotational movement of the member (casing 3002) rotatably coupled to the casing 3001. In addition, the electronic pen 3 can reduce power consumption even in the case as just described.

In addition, the housing member may be the cap 350 that is detachably fitted to the casing 3000 in such a manner as to cover the pen tip 375, the casing 3000 being provided with the pen tip 375.

Hence, the electronic pen 3 can improve the efficiency of the processing related to the electronic pen 3, where the processing is performed by the pen sensor 10 even in the case where the housing member is the cap 350. In addition, the electronic pen 3 can reduce power consumption even in the case where the housing member is the cap 350.

In addition, the housing member may be the casing of the electronic apparatus 1C having the hole portion 1050 into which the pen tip 375 is insertable.

Hence, the electronic pen 3 can improve the efficiency of the processing related to the electronic pen 3, where the processing is performed by the pen sensor 10 even in the case where the housing member is the electronic apparatus 1C having the hole portion 1050 into which the pen tip 375 is insertable. In addition, the electronic pen 3 can reduce power consumption even in the case as just described.

In addition, the electronic pen 3 further includes the detecting members 3053 and 3054 or 3051 and 3052 that detect a change in an electric field, a magnetic field, or a capacitance of a space including the pen tip 375. In addition, the pen controller 36 determines the housing state on the basis of a result of the detection of the detecting members 3053 and 3054 or 3051 and 3052.

Hence, the electronic pen 3 can use various detecting members in improving the efficiency of the processing related to the electronic pen 3, where the processing is performed by the pen sensor 10. In addition, the electronic pen 3 can use various detecting members in reducing power consumption.

In addition, the electronic pen 3 further includes the detecting members 3053 and 3054 that detect a change in an electric conduction state between the pen tip 375 and the housing member. In addition, the pen controller 36 determines the housing state on the basis of a result of the detection of the detecting members 3053 and 3054.

Hence, the electronic pen 3 can improve the efficiency of the processing related to the electronic pen 3, where the processing is performed by the pen sensor 10 by a simple configuration. In addition, the electronic pen 3 can reduce power consumption by a simple configuration.

In addition, the electrode 37 is the first electrode (electrode 37), and the electronic pen 3 further includes the second electrode (electrode 38). The second electrode (electrode 38) transmits and receives signals to and from the pen sensor 10, and is capable of receiving a signal transmitted from the first electrode. The second electrode is different from the first electrode. In addition, the pen controller 36 determines whether or not the pen tip 375 is housed in the housing member, on the basis of an amount of change in the signal level of the signal transmitted from the first electrode to the second electrode.

Hence, the electronic pen 3 can improve the efficiency of the processing related to the electronic pen 3, where the processing is performed by the pen sensor 10, with a small number of parts without constituent elements being added only to determine the housing state of the pen tip 375. In addition, the electronic pen 3 can reduce power consumption.

### Modifications

It is to be noted that the present disclosure is not limited to the foregoing embodiments. That is, the foregoing embodiments modified in design by those skilled in the art as appropriate are also included in the scope of the present disclosure as long as the modified embodiments have features of the present disclosure. In addition, elements included in the foregoing embodiments and modifications to be described later can be combined with one another where technically possible. Combinations of these elements are also included in the scope of the present disclosure as long as the combinations include features of the present disclosure.

For example, in the first embodiment, the pen pressure calculating section 23 calculates the pen pressure value according to variation in the potentials of both the position signal transmitted from the detection electrodes 11 and the position signal transmitted from the detection electrodes 12. However, there is no limitation to this. The pen pressure calculating section 23 may calculate the pen pressure value according to variation in the potential of one of the position signal transmitted from the detection electrodes 11 and the position signal transmitted from the detection electrodes 12. The same is true for the second embodiment. According to this configuration, the sensor controller 20 can calculate the pen pressure of the electronic pen 3 on the pen sensor 10 with higher sensitivity.

In addition, in the first embodiment and the second embodiment, in determining an amount of change in the potential of the position signal, the pen pressure calculating section 23 uses the amount of change within a predetermined time or uses a difference from a previously obtained potential. However, there is no limitation to this. The pen pressure calculating section 23 may calculate a difference of the potential of the position signal obtained this time from a moving average of the potential of the position signal obtained a predetermined number of times in the past, and calculate the pen pressure value according to variation in the difference. According to this configuration, the sensor controller 20 calculates the pen pressure value according to the difference from the moving average of the position signal in the past, and can therefore calculate the pen pressure of the electronic pen 3 on the pen sensor 10 with higher accuracy.

In addition, in the first embodiment, the pen pressure calculating section 23 calculates the pen pressure value to be one of the first value and the second value. However, there is no limitation to this. For example, when the operation state makes a transition between the first state and the second state, the pen pressure calculating section 23 may calculate the pen pressure value in such a manner as to make the pen pressure value change stepwise from the first value to the second value or from the second value to the first value.

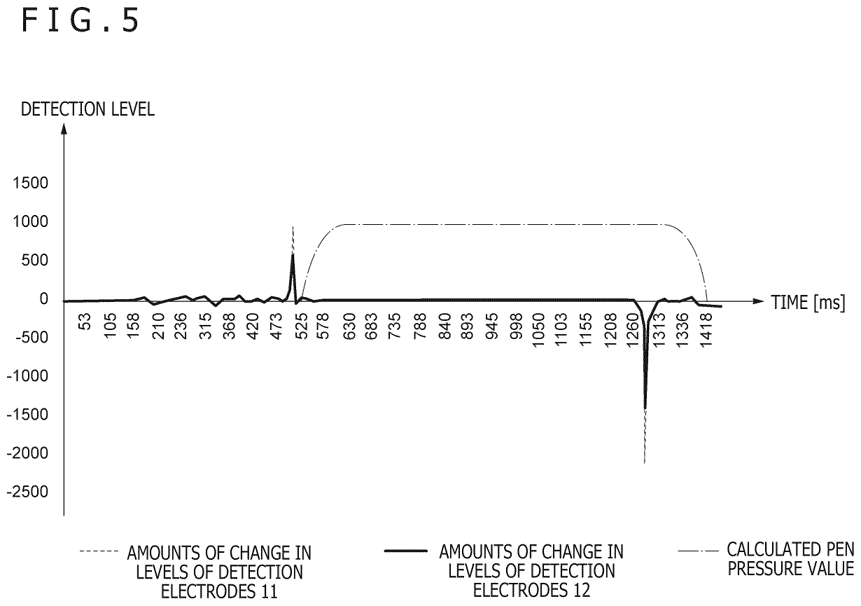

Here, another example of the calculation of the pen pressure value will be described with reference to FIG. 5. FIG. 5 is a graph illustrating another example of the relation between amounts of change in the level of the position signal and the pen pressure value in the first embodiment. As illustrated in FIG. 5, when the pen pressure calculating section 23 determines that the operation state has made a transition from the second state to the first state, the pen pressure calculating section 23 calculates the pen pressure value in such a manner as to make a gradual transition from the second value to the first value with the passage of time. In addition, when the pen pressure calculating section 23 determines that the operation state has made a transition from the first state to the second state, the pen pressure calculating section 23 calculates the pen pressure value in such a manner as to make a gradual transition from the first value to the second value with the passage of time. Incidentally, the pen pressure calculating section 23 makes the pen pressure value make a transition according to a predetermined function expression having the elapsed time as a variable, for example. In addition, the pen pressure calculating section 23 makes the pen pressure value make a transition by an amount indicated by a rate of change, an amount of change, or the like determined in advance for the elapsed time, for example.

According to this configuration, the pen pressure calculating section 23 of the sensor controller 20 calculates the pen pressure value in such a manner as to make a stepwise transition between the first value and the second value, and can therefore reduce abruptness and unnaturalness of drawing that can occur with a steep change in the pen pressure value.

In addition, in the second embodiment, the pen pressure calculating section 23 calculates the pen pressure value according to the position signal that is transmitted from a tip electrode provided to a tip end of the electronic pen 300 and is received by the pen sensor 100. However, there is no limitation to this. The pen pressure calculating section 23 may calculate the pen pressure value according to an amount of change in the potential of a posture signal that is transmitted from the ring electrode of the electronic pen 300 and includes the posture value of the electronic pen 300. According to this configuration, without depending on the position signal of the electronic pen 300, the sensor controller 20 can calculate the pen pressure value according to an amount of change in the potential of another signal.

In addition, the pen pressure calculating section 23 may change an amount of correction by which the pen pressure signal is corrected according to the position signal, according to an amount of change in the potential of the posture signal. Specifically, the pen pressure calculating section 23 may increase the amount of correction of the pen pressure signal when the amount of change in the potential of the posture signal is equal to or more than a reference potential, and the pen pressure calculating section 23 may decrease the amount of correction of the pen pressure signal when the amount of change in the potential of the posture signal is less than the reference potential. In addition, the pen pressure calculating section 23 may decrease the amount of correction of the pen pressure signal when the amount of change in the potential of the posture signal is equal to or more than the reference potential, and the pen pressure calculating section 23 may increase the amount of correction of the pen pressure signal when the amount of change in the potential of the posture signal is less than the reference potential. According to this configuration, the pen sensor controller 52 changes the correction amount according to the posture signal of the electronic pen 300 and can therefore calculate the pen pressure value with higher accuracy.

In addition, in the fourth embodiment, the pen pressure calculating section 23 determines the operation state of the electronic pen 3 according to whether or not an amount of change in the potential difference between the first signal and the second signal is equal to or more than a predetermined value. However, there is no limitation to this. The pen pressure calculating section 23 may determine the operation state of the electronic pen 3 according to whether or not a ratio of an amount of change in the potential of the second signal to an amount of change in the potential of the first signal is equal to or more than a predetermined ratio. The ratio of the amount of change in the potential of the second signal to the amount of change in the potential of the first signal is a result of dividing the amount of change in the potential of the first signal by the amount of change in the potential of the second signal. In addition, the predetermined ratio is, for example, 2, 3, or the like.

When the operation state of the electronic pen 3 makes a transition from the second state to the first state, the potential of the first signal detected by the pen sensor 10 rises sharply. On the other hand, when the operation state of the electronic pen 3 makes a transition from the first state to the second state, the potential of the first signal detected by the pen sensor 10 falls sharply. The above-described phenomenon occurs because an air layer present between the electronic pen 3 and the pen sensor 10 in a case where the electrode 37 of the electronic pen 3 is not in contact with the pen sensor 10 disappears when the electrode 37 of the electronic pen 3 comes into contact with the pen sensor 10. Incidentally, as for the potential of the second signal, a phenomenon similar to that of the first signal does not easily occur because a situation in which the electrode 38 that transmits and receives the second signal comes into contact with the pen sensor 10 does not easily occur. The present modification is based on a principle that, in light of the phenomenon, the operation state can be determined by determining whether or not the amount of change in the potential of the first signal and the amount of change in the potential of the second signal satisfy a predetermined condition.

Here, details of the above-described modification will be described with reference to FIG. 13 again. Incidentally, the processing other than the processing of step SP86 and the processing of step SP92 is similar to that of the fourth embodiment, and therefore, a description thereof will be omitted here.

### (Step SP86)

The pen pressure calculating section 23 determines whether or not the ratio of the amount of change in the potential of the second signal to the amount of change in the potential of the first signal is equal to or more than a first ratio. The first ratio is a ratio for determining whether or not the operation state has made a transition to the first state, which is a state in which the electronic pen 3 is pressing the pen sensor 10. Then, when the determination is a positive determination, the processing proceeds to the processing of step SP88. When the determination is a negative determination, on the other hand, the processing proceeds to the processing of step SP98.

### (Step SP92)

The pen pressure calculating section 23 determines whether or not the ratio of the amount of change in the potential of the second signal to the amount of change in the potential of the first signal is equal to or more than a second ratio. The second ratio is a ratio for determining whether or not the operation state has made a transition to the second state, which is a state in which the electronic pen 3 is separated from the pen sensor 10. Incidentally, the second ratio may be the same as the first ratio or may be different from the first ratio. Then, when the determination is a positive determination, the processing proceeds to the processing of step SP94. When the determination is a negative determination, on the other hand, the processing proceeds to the processing of step SP98.

Incidentally, the sensor controller 20 is not limited to the above-described example, but may store, for example, model data representing time transitions of a change in the potential of the first signal and a change in the potential of the second signal when the operation state of the electronic pen 3 changes from the first state to the second state. In addition, the sensor controller 20 may store model data representing time transitions of a change in the potential of the first signal and a change in the potential of the second signal when the operation state of the electronic pen 3 changes from the second state to the first state. The sensor controller 20 may refer to the model data for a change in the operation state of the electronic pen 3, and determine that the operation state has changed when the model data is matched or substantially matched.

According to this configuration, the sensor controller 20 determines the operation state of the electronic pen 3 according to whether or not the amount of change in the potential of the first signal and the amount of change in the potential of the second signal satisfy the predetermined condition. Hence, the sensor controller 20 can calculate the pen pressure of the electronic pen 3 on the pen sensor 10 with high accuracy even in a case where absolute values of the potentials of the first signal and the second signal vary due to model differences, manufacturing variation, or the like of the electronic pen 3, the pen sensor 10, and the like.

In addition, in the first to fourth embodiments, the position detection system 5 performs the potential change amount determination processing and the pen pressure value calculation processing in the same apparatus (for example, the electronic apparatus 1A, the electronic apparatus 1B, the electronic pen 3, or the like). However, there is no limitation to this. The position detection system 5 may perform the potential change amount determination processing and the pen pressure value calculation processing in respective different apparatuses. A specific example will be described with reference to FIG. 6 again. Incidentally, the processing of steps SP10 to SP16, step SP22, and step SP28 is similar to that of the first embodiment, and therefore, a description thereof will be omitted.

### (Step SP18)

Via the pen pressure calculating section 23, the electronic apparatus 1A determines that the operation state has made a transition from the second state to the first state. Via the pen pressure calculating section 23, the electronic apparatus 1A updates the operation state data 213 in the storage section 21 in such a manner as to indicate that the present operation state is the first state. Further, the electronic apparatus 1A transmits the uplink signal including a control instruction to calculate the pen pressure value to the electronic pen 3. Incidentally, the electronic apparatus 1A may transmit the control instruction to the electronic pen 3 by short-range wireless communication such as Bluetooth (registered trademark) rather than the uplink signal. The processing then proceeds to the processing of step SP20.

### (Step SP20)

Via the pen controller 36, the electronic pen 3 receives the uplink signal from the electronic apparatus 1A. Via the pen controller 36, the electronic pen 3 performs the pen pressure value calculation processing according to the control instruction to calculate the pen pressure value which control instruction is included in the uplink signal. The electronic pen 3, for example, calculates the pen pressure value as the first value in the pen pressure value calculation processing. In addition, the electronic pen 3, for example, calculates the pressure detected by the sensor 34 provided to the electronic pen 3 as the pen pressure value in the pen pressure value calculation processing. The electronic pen 3 transmits the downlink signal including the calculated pen pressure value to the electronic apparatus 1A. Incidentally, the electronic pen 3 may transmit the pen pressure value to the electronic apparatus 1A by short-range wireless communication such as Bluetooth (registered trademark) rather than the downlink signal. The processing then proceeds to the processing of step SP28.

### (Step SP24)

Via the pen pressure calculating section 23, the electronic apparatus 1A determines that the operation state has made a transition from the first state to the second state. Via the pen pressure calculating section 23, the electronic apparatus 1A updates the operation state data 213 in the storage section 21 in such a manner as to indicate that the present operation state is the second state. Further, the electronic apparatus 1A transmits the uplink signal including a control instruction to calculate the pen pressure value to the electronic pen 3. Incidentally, the electronic apparatus 1A may transmit the control instruction to the electronic pen 3 by short-range radio communication such as Bluetooth (registered trademark) rather than the uplink signal. The processing then proceeds to the processing of step SP26.

### (Step SP26)

Via the pen controller 36, the electronic pen 3 receives the uplink signal from the electronic apparatus 1A. Via the pen controller 36, the electronic pen 3 performs the pen pressure value calculation processing according to the control instruction to calculate the pen pressure value which control instruction is included in the uplink signal. The electronic pen 3, for example, calculates the pen pressure value as the second value in the pen pressure value calculation processing. In addition, the electronic pen 3, for example, calculates the pressure detected by the sensor 34 provided to the electronic pen 3 as the pen pressure value in the pen pressure value calculation processing. The electronic pen 3 transmits the downlink signal including the calculated pen pressure value to the electronic apparatus 1A. Incidentally, the electronic pen 3 may transmit the pen pressure value to the electronic apparatus 1A by short-range wireless communication such as Bluetooth (registered trademark) rather than the downlink signal. The processing then proceeds to the processing of step SP28.

According to this configuration, the position detection system 5 performs the potential change amount detection processing by the electronic apparatus 1A, and performs the pen pressure value calculation processing by the electronic pen 3 when the control instruction is transmitted from the electronic apparatus 1A. Hence, the position detection system 5 performs the pen pressure value calculation processing only when the control instruction is transmitted from the electronic apparatus 1A. It is therefore possible to suppress power consumption involved in the pen pressure value calculation processing and suppress a decrease in processing speed.

In addition, in the seventh embodiment, the electronic pen 3 switches the operation mode from the normal mode to the power saving mode according to a response transmitted from the pen sensor 10 when the electronic pen 3 determines that the state of the electronic pen 3 has changed to a state in which the pen tip 375 is housed in the housing member. However, there is no limitation to this. The electronic pen 3 may stop operating by completely turning off power according to a response transmitted from the pen sensor 10 when the electronic pen 3 determines that the state of the electronic pen 3 has changed to a state in which the pen tip 375 is housed in the housing member. That is, the electronic pen 3 may stop the operation of internal circuits such as the pen controller 36.

According to this configuration, the electronic pen 3 makes a notification to the pen sensor 10 according to the housing state of the pen tip 375 with respect to the housing member. In addition, the electronic pen 3 stops operating according to a response to the notification from the pen sensor 10. Hence, the operation of the electronic pen 3 is stopped by merely housing the pen tip 375, irrespective of an operating input by the user or the like. It is therefore possible to improve the convenience of the electronic pen 3. In addition, it is possible to improve the processing efficiency of the processing related to the electronic pen 3 which processing is performed by the pen sensor 10.

In addition, the electronic pen 3 switches the operation mode from the normal mode to the power saving mode according to a response transmitted from the pen sensor 10 when the electronic pen 3 determines that the state of the electronic pen 3 has changed to a state in which the pen tip 375 is housed in the housing member. However, there is no limitation to this. The sensor controller 20 that controls transmitting and receiving operations by the pen sensor 10 may change a scan mode when the pen sensor 10 receives a notification indicating that the state has changed to a state in which the pen tip 375 is housed in the housing member.

The scan mode will now be described. The sensor controller 20 has, for example, four kinds of modes illustrated in the following as the scan mode. The sensor controller 20 generally selects these modes in order illustrated in the following to perform the processing of detecting the positions of the electronic pen 3 and the finger 2.

A first mode is a mode of detecting the position of the finger 2. In the first mode, the sensor controller 20 temporarily stops the transmission and reception of signals to and from the electronic pen 3 and performs an operation of detecting a position indication by the finger 2 on the pen sensor 10. A second mode is a mode of transmitting the uplink signal to the electronic pen 3. A third mode is a mode of detecting a position indicated by the electronic pen 3 by receiving the downlink signal from the electronic pen 3. A fourth mode is a mode of obtaining various kinds of information regarding the electronic pen 3 by receiving the downlink signal from the electronic pen 3. That is, the second to fourth modes are modes of transmitting and receiving signals to and from the electronic pen 3.

When the pen sensor 10 receives a notification indicating that the state has changed to a state in which the pen tip 375 is housed in the housing member, the sensor controller 20 may perform switching from processing of sequentially selecting the first to fourth modes as the scan mode to processing of repeating the first mode. That is, when the state has changed to a state in which the pen tip 375 of the electronic pen 3 is housed in the housing member, the sensor controller 20 stops the transmission and reception of signals to and from the electronic pen 3 and changes the processing so as to perform an operation of detecting a position indication of the finger 2.

In addition, when the pen sensor 10 receives a notification indicating that the state has changed to a state in which the pen tip 375 is not housed in the housing member, the sensor controller 20 may perform switching from the processing of repeating the first mode as the scan mode to the processing of sequentially selecting the first to fourth modes as the scan mode. That is, when the state has changed to a state in which the pen tip 375 of the electronic pen 3 is not housed in the housing member, the sensor controller 20 changes the processing so as to perform, as usual, the detection of a position indication of the finger 2 and the transmission and reception of signals to and from the electronic pen 3.

According to this configuration, the position detection system 5 including the electronic pen 3 and the sensor controller 20 switches the scan mode of the sensor controller 20 according to the housing state of the pen tip 375 of the electronic pen 3 with respect to the housing member. Hence, the position detection system 5 stops the transmission and reception of signals between the pen sensor 10 and the electronic pen 3 when the pen tip 375 of the electronic pen 3 is housed. The position detection system 5 can therefore reduce the power consumption of the electronic pen 3 and the sensor controller 20. In addition, the position detection system 5 can improve the processing efficiency of the sensor controller 20.

1. A sensor controller, comprising:
an obtaining section configured to obtain a position signal indicating a position of an electronic pen from a pen sensor configured to detect the position of the electronic pen; and
a pen pressure calculating section configured to calculate a pen pressure value regarding a pen pressure of the electronic pen on the pen sensor on a basis of a change in a signal level of the position signal obtained by the obtaining section.

2. The sensor controller according to claim 1, wherein
the signal level is a potential, and,
when the potential of the position signal has risen by a first potential or more within a predetermined time, the pen pressure calculating section determines that an operation state has made a transition to a first state in which the electronic pen is pressing the pen sensor, and the pen pressure calculating section calculates the pen pressure value as a first value.

3. The sensor controller according to claim 2, wherein,
when the potential of the position signal has fallen by a second potential or more within a predetermined time, the pen pressure calculating section determines that the operation state has made a transition to a second state in which the electronic pen is separated from the pen sensor, and the pen pressure calculating section calculates the pen pressure value as a second value different from the first value.

4. The sensor controller according to claim 3, wherein,
when the operation state has made a transition from the second state to the first state, the pen pressure calculating section calculates the pen pressure value in such a manner as to make the pen pressure value change from the first value to the second value stepwise.

5. The sensor controller according to claim 2, wherein
the pen pressure calculating section calculates a movement speed of the electronic pen with respect to the pen sensor from the position signal and determines a value of the first potential according to the calculated movement speed.

6. The sensor controller according to claim 5, wherein
the pen pressure calculating section sets the value of the first potential to a value of a third potential when the movement speed is equal to or higher than a speed threshold value, and the pen pressure calculating section sets the value of the first potential to a value of a fourth potential higher than the third potential when the movement speed is lower than the speed threshold value.

7. The sensor controller according to claim 5, wherein
the pen pressure calculating section determines the value of the first potential such that the value of the first potential is proportional to the movement speed.

8. The sensor controller according to claim 2, wherein
the pen pressure calculating section calculates a movement speed of the electronic pen with respect to the pen sensor from the position signal and determines the first value according to the calculated movement speed.

9. The sensor controller according to claim 1, wherein
the pen pressure calculating section calculates the pen pressure value when a predetermined condition is not satisfied, and
the predetermined condition is a condition that a time elapsed since a previous calculation of the pen pressure value is less than a reference time and a distance traveled by the electronic pen since the previous calculation of the pen pressure value is less than a reference distance.

10. The sensor controller according to claim 9, wherein,
when the predetermined condition is satisfied, the pen pressure calculating section performs wait processing of making processing wait for a wait time in a case where the wait processing has not been performed after a previous determination for the predetermined condition, and the pen pressure calculating section calculates the pen pressure value in a case where the wait processing has been performed after the previous determination for the predetermined condition.

11. The sensor controller according to claim 1, wherein
the signal level is a potential,
the obtaining section obtains, from the pen sensor, a pen pressure signal that is transmitted from the electronic pen to the pen sensor and that indicates the pen pressure of the electronic pen on the pen sensor, and
the pen pressure calculating section calculates the pen pressure value by correcting the pen pressure indicated by the pen pressure signal on a basis of a change in the potential of the position signal.

12. The sensor controller according to claim 11, wherein,
when the potential of the position signal has risen by a first potential or more within a predetermined time, the pen pressure calculating section determines that an operation state has made a transition to a first state in which the electronic pen is pressing the pen sensor, and the pen pressure calculating section calculates the pen pressure value as a first value, and when the pen pressure signal obtained by the obtaining section indicates that the electronic pen is pressing the pen sensor before the pen pressure calculating section determines that the operation state has made a transition to the first state, the pen pressure calculating section determines that the pen pressure signal is indicating an abnormal value, and the pen pressure calculating section calculates the pen pressure value as a second value different from the first value.

13. The sensor controller according to claim 12, wherein,
when the potential of the position signal has fallen by a second potential or more within a predetermined time, the pen pressure calculating section determines that the operation state has made a transition to a second state in which the electronic pen is separated from the pen sensor, and the pen pressure calculating section calculates the pen pressure value as the second value, and when the pen pressure signal obtained by the obtaining section indicates that the pen sensor is separated from the electronic pen before the pen pressure calculating section determines that the operation state has made a transition to the second state, the pen pressure calculating section determines that the pen pressure signal is indicating an abnormal value, and the pen pressure calculating section maintains the pen pressure value.

14. A control method of a sensor controller connected to a pen sensor, the control method comprising:
obtaining a position signal indicating a position of an electronic pen from the pen sensor configured to detect the position of the electronic pen; and
calculating a pen pressure value regarding a pen pressure of the electronic pen on the pen sensor on a basis of a change in a signal level of the obtained position signal.

15. A sensor controller comprising:
an obtaining section configured to obtain, from a pen sensor configured to detect a position of an electronic pen, a first signal transmitted from a first electrode of the electronic pen to the pen sensor, a second signal transmitted from a second electrode of the electronic pen, the second electrode being different from the first electrode, to the pen sensor, and a pen pressure signal indicating a pen pressure of the electronic pen; and
a pen pressure calculating section configured to calculate a pen pressure value regarding the pen pressure of the electronic pen on the pen sensor on a basis of changes in signal levels of the first signal and the second signal obtained by the obtaining section as well as the pen pressure signal obtained by the obtaining section.

16. The sensor controller according to claim 15, wherein
the pen pressure calculating section calculates the pen pressure value such that, the larger an inclination angle of the electronic pen with respect to a detecting surface of the pen sensor, the larger the pen pressure value, and the smaller the inclination angle, the smaller the pen pressure value.

17. The sensor controller according to claim 15, wherein
the signal levels are potentials, and,
when the potential of the first signal or the second signal has risen by a first potential or more within a predetermined time, the pen pressure calculating section determines that an operation state has made a transition to a first state in which the electronic pen is pressing the pen sensor, and the pen pressure calculating section calculates the pen pressure value as a first value.

18. The sensor controller according to claim 15, wherein
the signal levels are potentials, and,
when a potential difference between the first signal and the second signal has risen by a first potential or more within a predetermined time, the pen pressure calculating section determines that an operation state has made a transition to a first state in which the electronic pen is pressing the pen sensor, and the pen pressure calculating section calculates the pen pressure value as a first value.
